(19) United States
(12) Patent Application Publication
(10) Pub. No.: US 2026/0340432 A1
(43) Pub. Date: Oct. 29, 2026

(54) DYNAMIC ARTIFICIAL INTELLIGENCE-DRIVEN DATA MANAGEMENT USING TAXONOMIZED KNOWLEDGE GRAPHS

(71) Applicant: International Business Machines Corporation, Armonk, NY (US)

(72) Inventors: Jacob Thomas COVELL, New York, NY (US); James Anthony MANISCALCO, New York, NY (US); Robert Huntington GRANT, Marietta, GA (US); Morgan FARRIOR, New York, NY (US)

(21) Appl. No.: 19/187,973

(22) Filed: Apr. 23, 2025

(51) Int. Cl. G06N 5/022; G06N 20/00

(52) U.S. Cl. CPC G06N 5/022; G06N 20/00

(57) ABSTRACT

A taxonomical data structure is generated based on multi-modal unstructured enterprise data and unstructured external data using a machine learning component. A taxonomized knowledge graph is constructed based on the taxonomical data structure using the machine learning component. New data is obtained from at least one of an external data source or an internal data source. An action associated with the new data is inferred using the machine learning component and based on the taxonomized knowledge graph and the new data. An indication of the action is output.

### BACKGROUND

The present invention relates to data management, and for example, relates to dynamic artificial intelligence-driven data management using taxonomized knowledge graphs.

### SUMMARY

In one embodiment, a computer-implemented method is provided. In this embodiment, the method includes generating, using a machine learning component, a taxonomical data structure based on multi-modal unstructured enterprise data and unstructured external data. The method further includes constructing, using the machine learning component and based on the taxonomical data structure, a taxonomized knowledge graph. Additionally, the method includes obtaining new data from at least one of an external data source or an internal data source. The method also includes inferring, using the machine learning component and based on the taxonomized knowledge graph and the new data, an action associated with the new data. Finally, the method includes outputting an indication of the action.

In another embodiment, a computer program product is provided. In this embodiment, the computer program product includes one or more computer-readable storage media and program instructions stored on the one or more computer-readable storage media to perform operations. The operations include generating, using a machine learning component, a taxonomical data structure based on multi-modal unstructured enterprise data and unstructured external data. The operations further include constructing, using the machine learning component and based on the taxonomical data structure, a taxonomized knowledge graph. Additionally, the operations include obtaining new data from at least one of an external data source or an internal data source. The operations also include inferring, using the machine learning component and based on the taxonomized knowledge graph and the new data, an action associated with the new data. Finally, the operations include outputting an indication of the action.

In yet another embodiment, a computer system is provided. In this embodiment, the computer system includes a processor set, one or more computer-readable storage media, and program instructions stored on the one or more computer-readable storage media to cause the processor set to perform operations. The operations include generating, using a machine learning component, a taxonomical data structure based on multi-modal unstructured enterprise data and unstructured external data. The operations further include constructing, using the machine learning component and based on the taxonomical data structure, a taxonomized knowledge graph. Additionally, the operations include obtaining new data from at least one of an external data source or an internal data source. The operations also include inferring, using the machine learning component and based on the taxonomized knowledge graph and the new data, an action associated with the new data. Finally, the operations include outputting an indication of the action.

### BRIEF DESCRIPTION OF THE DRAWINGS

FIG. 1A is a block diagram of an example computing system described herein.

FIG. 1B is another block diagram of the example computing system of FIG. 1A.

FIGS. 1C and 1D are data flow diagrams associated with the example computing system of FIGS. 1A and 1B.

FIGS. 2A-2D are schematic diagrams associated with dynamic data management.

FIG. 3 is a diagram of an example computing environment in which systems and/or methods described herein may be implemented.

FIG. 4 is a diagram of example components of one or more devices of FIG. 1.

FIG. 5 is a flowchart of an example technique associated with dynamic data management described herein.

### DETAILED DESCRIPTION

The following detailed description of example implementations refers to the accompanying drawings. The same reference numbers in different drawings may identify the same or similar elements.

In today's digital landscape, organizations face challenges in managing and analyzing vast amounts of unstructured data from diverse sources. The proliferation of digital communication channels, internal documentation, and external regulatory updates has led to an exponential increase in the volume and complexity of information that companies must process and act upon. Traditional data management systems struggle to efficiently categorize, contextualize, and extract meaningful insights from this deluge of unstructured data, particularly when it spans multiple modalities such as text, audio, and video. This technological limitation hinders organizations' ability to maintain up-to-date knowledge bases, ensure compliance with rapidly changing regulations, and make informed decisions based on the most current information available.

The dynamic nature of regulatory environments and internal policies further compounds the technical challenges faced by existing data management solutions. As new regulations are introduced or company policies are updated, organizations must quickly identify the impact of these changes across various departments and processes. Current systems often lack the capability to automatically analyze new information against existing knowledge bases, detect contradictions or conflicts, and determine the scope and severity of necessary updates. This deficiency leads to delays in implementing changes, increases the risk of non-compliance, and can result in inefficiencies due to outdated or conflicting procedures being followed across different teams.

Moreover, the siloed nature of many organizational structures exacerbates the technical difficulties in maintaining a cohesive and up-to-date knowledge base. Different departments often use separate systems and databases to store their information, making it challenging to create a unified view of the organization's collective knowledge. This fragmentation impedes the ability to identify cross-departmental impacts of new information or policy changes, potentially leading to inconsistencies in implementation and increased operational risks. The lack of a centralized, intelligent system capable of understanding the relationships between various pieces of information across departments hinders effective knowledge sharing and decision-making processes.

The absence of automated, context-aware notification systems further complicates the timely dissemination of updates throughout an organization. Current technologies often rely on manual processes or broad-based communications that fail to target the specific teams or individuals most affected by new information or policy changes. This inefficiency can lead to information overload for some employees while leaving others uninformed about updates important to their roles. The inability to automatically prioritize and tailor notifications based on the severity and relevance of changes limits organizations' agility in responding to new regulatory requirements or adapting to evolving business needs.

Implementations of this disclosure address problems such as these by providing a dynamic data management system that leverages machine learning and knowledge graph technologies to efficiently process, analyze, and act upon multi-modal unstructured data from diverse sources. The system generates a taxonomical data structure based on multi-modal unstructured enterprise data and unstructured external data, constructs a taxonomized knowledge graph from this structure, and uses machine learning to infer actions based on new data and the existing knowledge graph.

As used herein, the term “taxonomical data structure” refers to a hierarchical organization of information that categorizes data into topics, sub-topics, and individual data points (datum). For example, a taxonomical data structure in a financial services context might have “Know Your Customer (KYC)” as a top-level topic, “Enhanced Due Diligence” as a sub-topic, and specific procedural steps or regulatory requirements as datum. In some implementations, non-hierarchical or network-based taxonomical structures that capture complex relationships between different data elements may be included.

The “taxonomized knowledge graph” represents the relationships and connections between different elements of the taxonomical data structure. In some implementations, the knowledge graph may consist of nodes representing topics and sub-topics, with edges representing relationships between these nodes. For instance, a node representing “Transaction Monitoring” might be connected to a “KYC” node, indicating a dependency or sequential relationship. The knowledge graph may be continuously updated and refined as new information is processed, allowing for dynamic representation of an organization's collective knowledge.

In some implementations, the system may employ a multi-model natural language processing operation to extract a set of datum from the multi-modal unstructured enterprise data. This operation may involve techniques such as named entity recognition, sentiment analysis, and context understanding to accurately interpret and categorize information from various sources, including text documents, audio recordings, and video content. For example, the system might extract specific compliance requirements from a regulatory document, identify stakeholders from meeting minutes, and determine process sequences from training videos.

The machine learning component used in this system may comprise a generative artificial intelligence component capable of understanding complex relationships and generating insights from the processed data. In some implementations, this component may use techniques such as transfer learning or few-shot learning to quickly adapt to new domains or types of data without requiring extensive retraining. The generative AI may be used not only for constructing the taxonomical data structure and knowledge graph but also for inferring appropriate actions based on new information.

When new data is obtained from external or internal sources, the system determines a weighted severity score based on various factors such as the source of the information, the type of mandate (e.g., enforced vs. suggested), and the timing of implementation. In some implementations, the system may also calculate an impact score by analyzing the scope of the change within the context of the existing knowledge graph. For instance, a minor policy update affecting a single team might receive a low impact score, while a major regulatory change impacting multiple departments would receive a high impact score.

Based on the weighted severity score, impact score, and other contextual factors, the system infers an appropriate action associated with the new data. Actions may include outputting notifications, updating process or policy documents, or providing specific instructions to relevant teams. In some implementations, the system may determine a set of candidate actions and their associated estimated costs, allowing for cost-sensitive decision-making. For example, for a low-severity update, the system might choose to send a simple notification, while for a high-impact change, it could automatically draft detailed process updates and schedule training sessions.

The system incorporates multiple feedback loops to continuously improve its performance. In some implementations, users may provide feedback on the taxonomical data library, severity scores, impact assessments, and suggested actions through a user interface. This feedback is used to update and refine the machine learning component, enhancing the accuracy and relevance of future inferences. Additionally, the system may perform fact-checking or verification operations by cross-referencing new information with connected external data sources, ensuring the reliability and consistency of the knowledge base.

In some implementations, the system generates a taxonomical data structure based on multi-modal unstructured enterprise data and unstructured external data. Accordingly, an advantage of the taxonomical data structure is its ability to organize and categorize diverse types of information from multiple sources into a coherent framework. Additionally, an advantage of the taxonomical data structure is its flexibility in accommodating various data formats, including text, audio, and video content. Furthermore, an advantage of the taxonomical data structure is its capacity to reveal relationships and dependencies between different pieces of information that may not be immediately apparent in the raw data.

In some implementations, the system constructs a taxonomized knowledge graph based on the taxonomical data structure. Accordingly, an advantage of the taxonomized knowledge graph is its ability to represent complex relationships between different elements of an organization's collective knowledge in a visually intuitive manner. Additionally, an advantage of the taxonomized knowledge graph is its capacity to facilitate efficient querying and traversal of interconnected information. Moreover, an advantage of the taxonomized knowledge graph is its adaptability to incorporate new information dynamically, allowing for continuous updates and refinements to the organization's knowledge base.

In some implementations, the system infers actions associated with new data based on the taxonomized knowledge graph and a machine learning component. Accordingly, an advantage of this inference capability is its ability to automatically identify relevant teams, processes, or policies that may be impacted by new information or regulatory changes. Additionally, an advantage of this inference capability is its potential to reduce response times to updates by quickly determining appropriate actions. Furthermore, an advantage of this inference capability is its ability to prioritize and tailor notifications based on the severity and relevance of changes, thereby reducing information overload and ensuring that stakeholders receive timely, actionable insights.

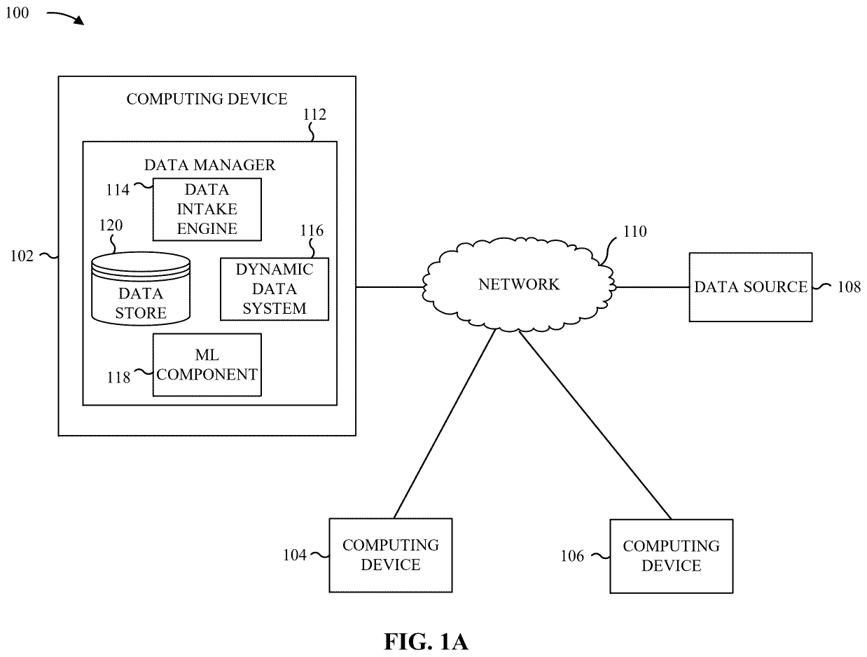

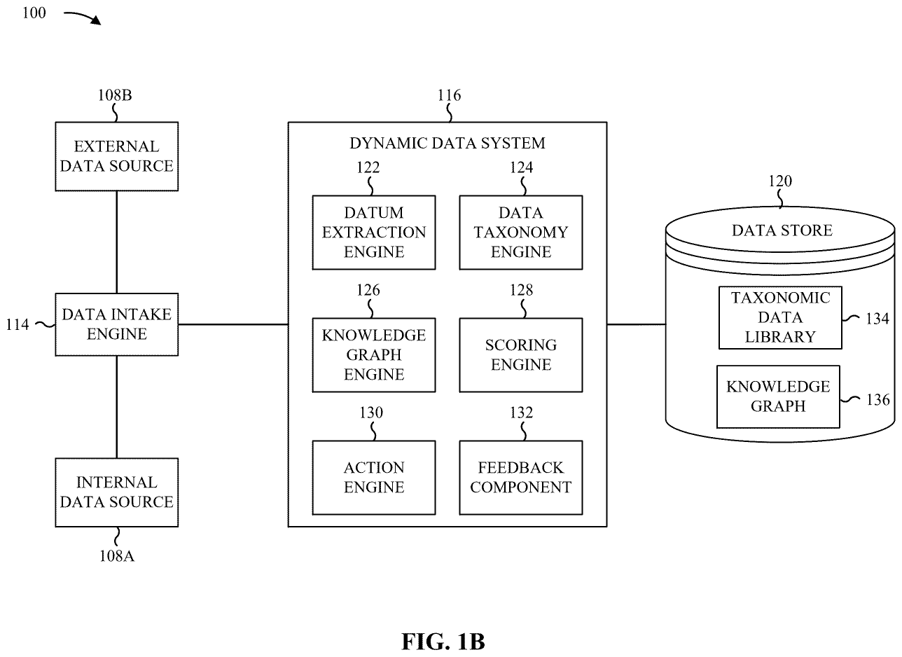

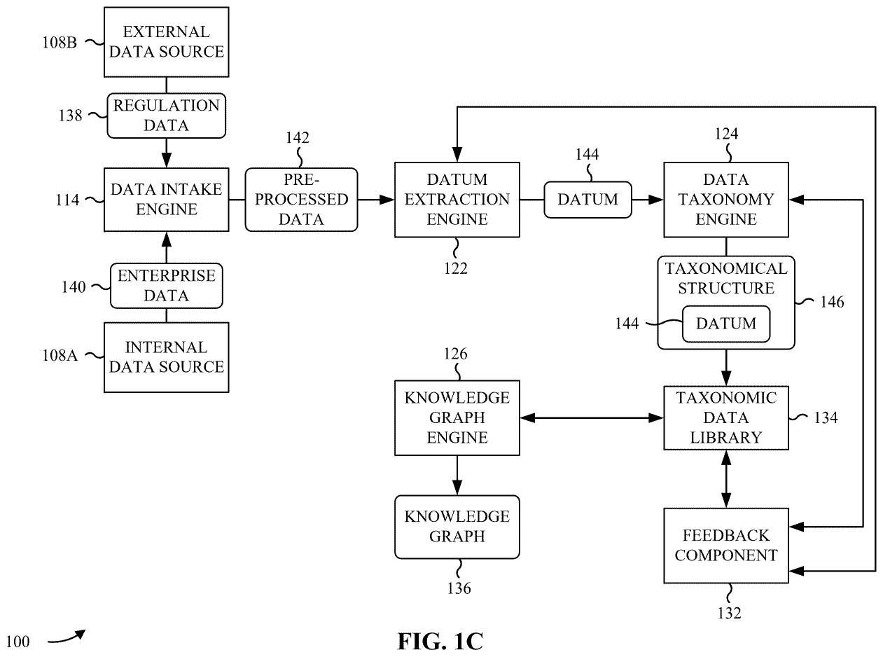

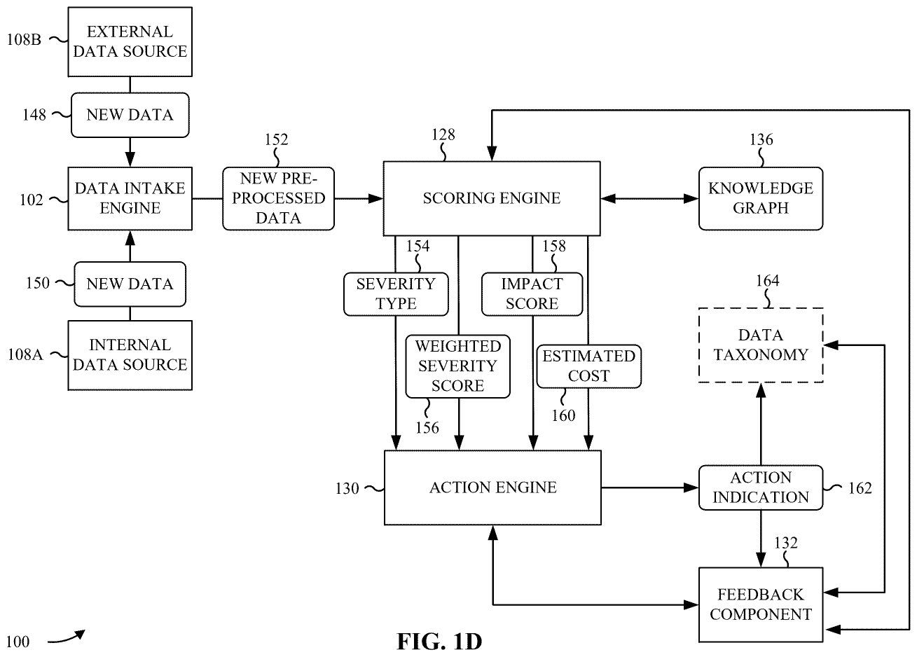

FIG. 1A is a block diagram of an example computing system 100 for dynamic data management using taxonomized knowledge graphs. As shown, the computing system 100 includes computing devices 102, 104, and 106, a data source 108, and a network 110. The computing devices 102, 104, and 106 are configured to interact with each other and the data source 108 via the network 110 to facilitate dynamic data management and analysis. The computing devices 102, 104, and 106 are configured to interact with each other and the data source 108 via the network 110 to facilitate dynamic data management and analysis. In some implementations, one or more of the computing devices 102, 104, and 106 may refer to any number of computing devices. In some implementations, one or more of the computing devices 102, 104, and 106 may refer to one or more virtual computing devices operating on one or more physical computing devices. In some implementations, the computing system 100 may include any number of additional computing devices (not shown) in addition to the computing devices 102, 104, and 106.

In some implementations, the computing devices 102, 104, and 106 may be part of an enterprise network infrastructure. These devices may represent various departments or teams within the organization, such as compliance, risk management, or operations. Each computing device may have access to specific sets of data and documents relevant to its function, while also being able to communicate and share information with other devices in the network. The enterprise setup may allow for a distributed approach to data management and analysis. For example, computing device 102 might be dedicated to processing and analyzing regulatory updates, while computing device 104 could focus on internal policy changes, and computing device 106 might handle customer-related data. This distribution of tasks across multiple devices can enable parallel processing of information, potentially improving the overall efficiency of the dynamic data management system. In some implementations, the enterprise configuration may also facilitate role-based access control and data governance. Each computing device may have different levels of access to the taxonomized knowledge graph and associated data, based on the responsibilities and clearance levels of the teams or individuals using those devices. This setup may help maintain data security and compliance with internal policies and external regulations, while still allowing for the necessary flow of information across the organization.

The computing device 102 may be any type of computing device, such as, for example, a server computer, a desktop computer, a laptop computer, or a tablet computer. In some implementations, the computing device 102 may refer to a virtual computing device that may operate as part of a cloud computing environment. The computing device 102 may include any number of computing devices, and each computing device may host any number of software applications. The computing device 102 includes a data manager 112, which includes several components for processing and analyzing data. In some implementations, the data manager 112 may include a data intake engine 114, a dynamic data system 116, a machine learning component 118, and a data store 120. These components work together to generate taxonomical data structures, construct taxonomized knowledge graphs, and infer actions based on new data. Any two or more of the data intake engine 114, the dynamic data system 116, the machine learning component 118, and the data store 120 may be integrated into a single component. Any one or more of the data intake engine 114, the dynamic data system 116, the machine learning component 118, and the data store 120 may be distributed across any number of devices such as, for example, the computing devices 102, 104, and 106.

The data intake engine 114 may be configured to obtain data from the data source 108 through the network 110. In some implementations, the data intake engine 114 may facilitate the ingestion of multi-modal unstructured enterprise data and unstructured external data. The data intake engine 114 may employ various data acquisition techniques to gather information from diverse sources, including internal databases, external APIs, and web scraping.

The data intake engine 114 may be designed to handle a wide variety of data formats and sources, enabling the system to process information from both structured and unstructured sources. In some implementations, the data intake engine 114 may include specialized connectors or adapters for interfacing with different types of data repositories, such as relational databases, document management systems, email servers, and cloud storage platforms. These connectors may allow the data intake engine 114 to efficiently extract data while maintaining the integrity and context of the original information.

In some aspects, the data intake engine 114 may incorporate advanced text parsing and natural language processing (NLP) capabilities to handle unstructured text data from sources such as policy documents, regulatory filings, and internal communications. The data intake engine 114 may be capable of identifying and extracting key information such as dates, names, monetary values, and specific terminology relevant to the organization's domain. In some implementations, the data intake engine 114 may include components for processing audio and/or video content, utilizing speech-to-text conversion and computer vision techniques to extract relevant information from multimedia sources.

The data intake engine 114 may implement data validation and quality assurance mechanisms to ensure the accuracy and reliability of the ingested information. In some implementations, this may involve cross-referencing incoming data against existing records, flagging potential inconsistencies or duplicates, and applying data cleansing algorithms to standardize formats and resolve discrepancies. The data intake engine 114 may maintain detailed metadata about the ingested data, including source information, timestamp, and any transformations applied during the intake process, which can be used for maintaining data lineage and supporting audit trails.

In some implementations, the data intake engine 114 may be designed with scalability and performance in mind, capable of handling large volumes of data in real-time or through batch processing, depending on the organization's needs. In some aspects, the data intake engine 114 may utilize distributed processing techniques, allowing it to parallelize data ingestion tasks across multiple nodes or servers to improve throughput and reduce processing time. The data intake engine 114 may incorporate scheduling and prioritization mechanisms to manage the flow of data into the system, facilitating prompt processing or time-sensitive information while optimizing resource utilization for less urgent data streams.

The dynamic data system 116 interfaces with the data intake engine 114 and may be configured to process the received data. In some implementations, the dynamic data system 116 may include components for data cleaning, normalization, and transformation. The dynamic data system 116 may also facilitate the extraction of relevant features and metadata from the ingested data, preparing it for further analysis by the machine learning component 118.

The dynamic data system 116 may serve as a central processing hub within the computing system 100, orchestrating the flow of data between various components and performing analytical operations. In some implementations, the dynamic data system 116 may employ a modular architecture, allowing for the integration of specialized processing units tailored to specific data types or analytical tasks. This modular approach may enable the system to adapt to changing organizational needs and incorporate new data processing capabilities as they become available.

The dynamic data system 116 may include a data transformation module that standardizes and normalizes incoming data from diverse sources. This module may apply various techniques such as data type conversion, unit standardization, and format harmonization to ensure consistency across the dataset. In some cases, the data transformation module may utilize machine learning algorithms to detect and correct anomalies, fill in missing values, or reconcile conflicting information from different sources. The transformed data may then be passed to other components within the dynamic data system 116 for further processing and analysis.

In some implementations, the dynamic data system 116 may incorporate a feature extraction engine that identifies and extracts relevant attributes from the processed data. This engine may utilize natural language processing techniques to derive semantic meaning from textual data, image recognition algorithms to extract information from visual content, and signal processing methods to analyze audio data. The extracted features may be used to enrich the taxonomical data structure and knowledge graph, providing additional context and relationships that can be leveraged in subsequent analysis tasks. The feature extraction engine may generate metadata tags that facilitate efficient searching and categorization of information within the system.

The dynamic data system 116 may include a data integration component that combines information from multiple sources to create a unified view of the organization's knowledge base. This component may employ advanced entity resolution techniques to identify and merge duplicate records, establish links between related pieces of information, and resolve conflicts between different data sources. In some aspects, the data integration component may utilize probabilistic matching algorithms and machine learning models to handle complex integration scenarios where exact matches are not possible. The integrated data may then be used to update and refine the taxonomized knowledge graph, so that it reflects a current and comprehensive understanding of the organization's information landscape.

The machine learning component 118 may be configured to perform advanced analysis and inference tasks. A machine learning (ML) component refers to hardware and/or software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, discriminating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of NLP, ML training software can employ a learning paradigm focused on human preferences to better align pretrained and instruction-tuned generative language models with human values. This process involves the ML training software collecting extensive data, where each data point comprises a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

In some implementations, the ML component 118 may be, include, or be included in any number of different systems or engines. While the ML component 118 is shown and described as a subsystem of the computing device 102, it should be understood that components of the ML component 118 may additionally or alternatively be implemented within the computing device 104, the computing device 106, the data source 108, and/or within another computing device or component not shown. In some implementations, the computing device 102 may include the ML component 118 with the dynamic data system 116. In some implementations, the data intake engine 114 and/or the dynamic data system 116 may include the ML component 118. In implementations, the ML component 118 may include any number of ML models trained to perform any number of different tasks (e.g., natural language processing, semantic analysis, image classification, anomaly detection, etc.) In some implementations, the ML components implemented within the computing system may be implemented using other techniques such as machine learning software distributed using a cloud computing service (e.g., Microsoft Azure®, Amazon AWS®, or any other suitable cloud service).

The data store 120 provides storage capabilities for the computing system 100. In some implementations, the data store 120 may house the taxonomical data structure, taxonomized knowledge graph, and other processed information generated by the system. The data store 120 may be implemented using various database technologies, including relational databases, graph databases, or distributed storage systems, depending on the specific requirements of the implementation.

The data store 120 may be implemented as a distributed storage system that allows for efficient storage and retrieval of large volumes of structured and unstructured data. In some implementations, the data store 120 may utilize a in-memory caching, persistent disk storage, or a combination thereof to optimize performance. The in-memory caching component may store frequently accessed data, such as portions of the taxonomized knowledge graph or recently processed information, allowing for rapid retrieval and analysis. The persistent disk storage may house historical data, complete versions of the taxonomical data structure, and archived information that is not immediately required for real-time processing.

In some implementations, the data store 120 may employ a hybrid approach, combining features of both relational and graph databases to accommodate the diverse data types handled by the system. The relational component may store structured data in tables with predefined schemas, facilitating efficient querying and data manipulation using SQL-like languages. Meanwhile, the graph database component may be optimized for storing and querying the taxonomized knowledge graph, allowing for rapid traversal of complex relationships between entities. This hybrid architecture may enable the system to leverage the strengths of both database paradigms, providing flexibility in data storage and retrieval based on the specific requirements of different data types and use cases.

The data store 120 may also incorporate advanced data management features such as versioning, partitioning, and replication. Versioning capabilities may allow the system to maintain historical snapshots of the taxonomical data structure and knowledge graph, facilitating rollback to previous states if needed and facilitating audit trails of changes over time. Data partitioning may be employed to distribute large datasets across multiple storage nodes, improving query performance and enabling parallel processing of data. Replication mechanisms may ensure data redundancy and high availability, with multiple copies of critical data maintained across different physical or virtual storage locations to mitigate the risk of data loss and minimize system downtime.

The data source 108 may include various types of data repositories and information sources that provide input to the computing system 100. In some implementations, the data source 108 may include internal or external data sources, allowing the system to process and analyze information from diverse origins. Internal data sources may include enterprise databases, document management systems, customer relationship management (CRM) platforms, and internal communication channels such as email servers or collaboration tools. External data sources may encompass public databases, regulatory websites, industry publications, social media platforms, and third-party data providers.

The data source 108 may support multiple data formats and structures to accommodate the diverse nature of information relevant to the organization. In some cases, the data source 108 may include structured data stored in relational databases or spreadsheets, semi-structured data such as extensible markup language (XML) or JavaScript Object Notation (JSON) files, and unstructured data like text documents, images, or audio recordings. The computing system 100 may be capable of ingesting and processing data from these varied formats, enabling a comprehensive analysis of the organization's information landscape. Additionally, the data source 108 may incorporate real-time data streams, allowing the system to capture and analyze time-sensitive information as it becomes available.

In some implementations, the data source 108 may include mechanisms for data quality assurance and metadata management. These features may help ensure the reliability and contextual understanding of the information being processed by the computing system 100. The data source 108 may implement access control and security measures to protect sensitive information and ensure compliance with data privacy regulations. By providing a diverse and well-managed set of data inputs, the data source 108 may enable the computing system 100 to generate more accurate and comprehensive taxonomical data structures and knowledge graphs, ultimately enhancing the system's ability to infer actions and provide valuable insights to the organization.

FIG. 1B provides a more detailed view of the computing system 100, focusing on the components involved in the dynamic data management process. The figure illustrates the interaction between external data source 108B, internal data source 108A, and various components of the dynamic data system 116.

The data intake engine 114 in FIG. 1B is shown interfacing with both the external data source 108B and the internal data source 108A. This configuration allows the system to ingest and process data from multiple sources, facilitating a comprehensive analysis of both internal and external information.

Within the dynamic data system 116, several specialized engines and components are depicted. The datum extraction engine 122 is responsible for extracting individual data points or datum from the ingested information. In some implementations, the datum extraction engine 122 may employ advanced natural language processing techniques to identify and isolate relevant pieces of information from unstructured text, images, or other media formats.

The datum extraction engine 122 may utilize rule-based approaches, machine learning approaches, or a combination thereof to effectively process and extract relevant information from diverse data sources. In some implementations, the datum extraction engine 122 may employ NLP techniques such as named entity recognition, part-of-speech tagging, and dependency parsing to identify key elements within textual data. These techniques may allow the engine to recognize and extract specific types of information, such as names, dates, locations, and numerical values, even when they appear in unstructured formats or complex sentence structures.

For non-textual data sources, the datum extraction engine 122 may incorporate specialized modules designed to handle various media types. In some cases, the datum extraction engine 122 may use optical character recognition (OCR) technology to extract text from images or scanned documents, enabling the processing of information from physical documents or graphical representations. For audio data, the datum extraction engine 122 may employ speech recognition algorithms to transcribe spoken content into text, which can then be further analyzed using NLP techniques. In implementations dealing with video content, the datum extraction engine 122 may combine visual analysis techniques with audio processing to extract relevant information from both the visual and auditory components of the media.

The datum extraction engine 122 may include adaptive learning capabilities that allow it to improve its extraction accuracy over time. In some implementations, the engine may utilize feedback mechanisms to refine its extraction rules and models based on user interactions or validation processes. This adaptive approach may help the datum extraction engine 122 to handle evolving data formats, domain-specific terminology, and organization-specific information structures more effectively. Additionally, the datum extraction engine 122 may incorporate context-aware extraction techniques that consider the broader context of the data source, such as document type, industry sector, or temporal relevance, to enhance the precision and relevance of the extracted datum.

The data taxonomy engine 124 works in conjunction with the datum extraction engine 122 to organize the extracted data into a structured taxonomy. In some implementations, the data taxonomy engine 124 may utilize machine learning algorithms to categorize information into hierarchical relationships, creating a coherent structure that reflects the relationships between different pieces of data.

The data taxonomy engine 124 may employ machine learning techniques to analyze and categorize the extracted datum into a hierarchical structure. In some implementations, the data taxonomy engine 124 may utilize unsupervised learning algorithms, such as hierarchical clustering or topic modeling, to identify natural groupings and relationships within the data. These algorithms may help discover latent patterns and themes that may not be immediately apparent, allowing for a more nuanced and comprehensive taxonomy. In some implementations, the data taxonomy engine 124 may incorporate supervised learning approaches, leveraging pre-existing taxonomies or expert-labeled datasets to guide the categorization process and ensure alignment with industry-specific or organizational standards.

In some implementations, the data taxonomy engine 124 may implement a multi-stage processing pipeline to refine and optimize the taxonomical structure. This pipeline may include steps such as data preprocessing, feature extraction, dimensionality reduction, and iterative clustering. The data taxonomy engine 124 may apply techniques like term frequency-inverse document frequency (TF-IDF) weighting or word embeddings to capture semantic relationships between terms and concepts. In some implementations, the data taxonomy engine 124 may utilize ensemble methods, combining multiple taxonomical models to improve robustness and accuracy. The data taxonomy engine 124 may incorporate domain-specific ontologies or knowledge bases to enrich the taxonomical structure with additional context and relationships.

The data taxonomy engine 124 may include mechanisms for refinement and adaptation of the taxonomical structure. In some implementations, the data taxonomy engine 124 may employ active learning techniques to identify areas of uncertainty in the taxonomy and solicit targeted feedback from domain experts or users. This feedback may be used to update and improve the underlying machine learning models, enhancing the accuracy and relevance of the taxonomy over time. The data taxonomy engine 124 may implement versioning and change management capabilities, allowing organizations to track the evolution of their taxonomical structures and revert to previous versions if needed. In some cases, the data taxonomy engine 124 may provide visualization tools to help users explore and interact with the taxonomy, facilitating a better understanding of the relationships between different categories and concepts within the organization's information landscape.

The knowledge graph engine 126 is a component that constructs the taxonomized knowledge graph based on the taxonomical data structure generated by the data taxonomy engine 124. In some implementations, the knowledge graph engine 126 may create networks of interconnected nodes and edges, representing entities, concepts, and their relationships within the organization's data ecosystem.

The knowledge graph engine 126 may employ graph construction algorithms to transform the taxonomical data structure into a comprehensive knowledge graph. In some implementations, the knowledge graph engine 126 may utilize entity linking techniques to identify and connect related concepts across different data sources and domains. This process may involve resolving entity ambiguities, merging duplicate entities, and establishing hierarchical and non-hierarchical relationships between nodes in the graph. The knowledge graph engine 126 may incorporate temporal aspects, allowing the representation of time-dependent relationships and the evolution of concepts over time.

In some cases, the knowledge graph engine 126 may leverage natural language processing and machine learning techniques to extract implicit relationships from unstructured text data. This may include the identification of causal relationships, dependencies, and semantic similarities between entities that are not explicitly stated in the source data. The knowledge graph engine 126 may integrate external knowledge bases or ontologies to enrich the graph with additional context and domain-specific information. This integration may enhance the system's ability to make inferences and discover non-obvious connections within the organization's data ecosystem.

The knowledge graph engine 126 may implement dynamic graph update mechanisms to maintain the relevance and accuracy of the knowledge representation over time. As new data is ingested and processed by the system, the knowledge graph engine 126 may automatically update the graph structure, adding new nodes and edges, modifying existing relationships, or pruning outdated information. In some implementations, the knowledge graph engine 126 may employ graph embedding techniques to generate low-dimensional vector representations of nodes and edges, facilitating efficient similarity computations and enabling advanced graph analytics capabilities. These embeddings may be used to power recommendation systems, anomaly detection algorithms, or other downstream applications that leverage the knowledge graph's structural properties.

The scoring engine 128 may be configured to analyze new data in the context of the existing taxonomized knowledge graph. In some implementations, the scoring engine 128 may calculate various metrics, such as impact scores and severity scores, to quantify the importance of new information and its potential effects on existing processes or policies.

The scoring engine 128 may employ a multi-faceted approach to evaluate the significance and potential impact of new data within the context of the existing taxonomized knowledge graph. In some implementations, the scoring engine 128 may utilize machine learning algorithms (e.g., via the ML component 118), such as gradient boosting or neural networks, to analyze various features of the new data and its relationships to existing nodes in the knowledge graph. These features may include the source of the information, its relevance to specific organizational processes or policies, and its temporal proximity to recent events or decisions. The scoring engine 128 may assign weights to different features based on their relative importance, which may be dynamically adjusted over time as the system learns from user feedback and observed outcomes.

In some cases, the scoring engine 128 may incorporate domain-specific heuristics and rules to complement its machine learning capabilities. For example, in a financial compliance context, the scoring engine 128 may apply predefined scoring criteria for regulatory updates based on factors such as the issuing authority, the scope of affected processes, and the deadline for implementation. The scoring engine 128 may consider the structural properties of the knowledge graph when calculating impact scores, such as the centrality of affected nodes or the number of downstream dependencies. This graph-based analysis may help identify potential ripple effects of new information across different departments or business functions.

The scoring engine 128 may generate multiple types of scores to provide a comprehensive assessment of new data. In some implementations, these may include a severity score that quantifies the urgency or criticality of the information, an impact score that estimates the breadth and depth of potential effects on existing processes, and a confidence score that reflects the reliability of the data source and the certainty of the engine's assessment. The scoring engine 128 may produce explanatory metadata alongside these scores, providing context and justification for its evaluations. This metadata may include references to relevant nodes in the knowledge graph, highlighting the key relationships and dependencies that influenced the scoring process. The scores and associated metadata generated by the scoring engine 128 may serve as inputs for the action engine 130, guiding the system's decision-making process for determining appropriate responses to new information.

The action engine 130 leverages the outputs from the scoring engine 128 and the knowledge graph engine 126 to infer appropriate actions based on new data. In some implementations, the action engine 130 may generate recommendations for updating documents, notifying specific teams, or initiating new processes based on the analyzed information.

The action engine 130 may employ rule-based approaches, machine learning approaches, or a combination thereof to determine the most appropriate actions based on the outputs from the scoring engine 128 and the knowledge graph engine 126. In some implementations, the action engine 130 may utilize a decision tree or a random forest algorithm to map different combinations of scores and graph properties to specific action categories. These categories may include document updates, team notifications, process initiations, or escalations to higher-level decision-makers. The action engine 130 may incorporate reinforcement learning techniques to optimize its decision-making process over time, learning from the outcomes of previous actions and adjusting its recommendations accordingly.

The action engine 130 may generate detailed action plans that specify not only the type of action to be taken but also the sequence of steps, responsible parties, and estimated timelines for implementation. In some cases, the action engine 130 may leverage natural language generation techniques to produce human-readable summaries of its recommendations, tailoring the language and level of detail to different stakeholder groups within the organization. The action engine 130 may include a prioritization mechanism that balances the urgency of actions against available resources and potential conflicts with ongoing initiatives, ensuring that the most critical and impactful actions are addressed first.

In some implementations, the action engine 130 may interface with other enterprise systems to automate the execution of certain actions. For example, the action engine 130 may integrate with document management systems to initiate version control processes for policy updates, or with communication platforms to send targeted notifications to relevant team members. The action engine 130 may maintain an audit trail of recommended actions and their outcomes, providing data for compliance reporting and continuous improvement of the system's decision-making capabilities. In some implementations, the action engine 130 may include a feedback loop that allows users to provide input on the appropriateness and effectiveness of recommended actions, further refining its ability to generate contextually relevant and impactful recommendations over time.

The feedback component 132 may collect user feedback on various aspects of the system's output, including the accuracy of inferred actions, the relevance of notifications, and the structure of the taxonomical data library. This feedback may be used to refine and update the machine learning models and algorithms used throughout the system. The feedback component 132 may implement a multi-channel approach to gather user input and system performance data. In some implementations, the feedback component 132 may include interactive elements within the user interface that allow users to provide immediate feedback on specific actions, recommendations, or taxonomical classifications. These elements may take the form of rating scales, comment boxes, or simple thumbs-up/thumbs-down buttons. The feedback component 132 may incorporate passive feedback collection methods, such as tracking user interactions with the system, monitoring which recommendations are acted upon, and analyzing patterns of system usage across different teams or departments.

In some cases, the feedback component 132 may employ natural language processing techniques to analyze free-text feedback provided by users, extracting sentiment, key themes, and specific suggestions for improvement. This analysis may help identify recurring issues or areas of the system that consistently receive positive or negative feedback. The feedback component 132 may integrate with external data sources, such as customer support tickets or internal communication channels, to gather additional context and insights about the system's performance and impact on organizational processes.

The feedback component 132 may include mechanisms for aggregating and synthesizing feedback from multiple sources to generate actionable insights for system improvement. In some implementations, the feedback component 132 may use machine learning algorithms to identify patterns and trends in the collected feedback, automatically flagging areas that may require attention or optimization. The feedback component 132 may generate periodic reports or dashboards that summarize key feedback metrics, allowing system administrators and developers to track the evolution of user satisfaction and system performance over time. These insights may be used to prioritize feature development, refine existing algorithms, or adjust the system's behavior to better align with user needs and organizational goals.

The data store 120 in FIG. 1B is shown to contain two data structures: the taxonomic data library 134 and the knowledge graph 136. The taxonomic data library 134 may store the hierarchical organization of data generated by the data taxonomy engine 124. In some implementations, this library may serve as a reference for categorizing new information and maintaining consistency in data classification across the organization. The knowledge graph 136 represents the interconnected network of information constructed by the knowledge graph engine 126. In some implementations, the knowledge graph 136 may be a dynamic structure that is continuously updated as new data is processed and analyzed by the system. This graph may facilitate complex queries, relationship discovery, and impact analysis when new information is introduced to the system.

In operation, the computing system 100 may receive new data from the external data source 108B and/or the internal data source 108A. This new data is processed through the data intake engine 114 and then analyzed by the various components of the dynamic data system 116. The system may leverage the existing taxonomic data library 134 and knowledge graph 136 to contextualize the new information and determine its potential impact on the organization. Based on this analysis, the action engine 130 may infer appropriate actions, which could include updating process documents, modifying policies, or notifying specific teams about relevant changes. The inferred actions may be outputted as indications, which can be reviewed and acted upon by relevant stakeholders within the organization. Throughout this process, the feedback component 132 may collect input from users interacting with the system's outputs. This feedback may be used to refine the machine learning models, improve the accuracy of inferred actions, and enhance the overall performance of the computing system 100.

FIGS. 1C and 1D are diagrams illustrating an example of a process for dynamic data management using taxonomized knowledge graphs. In some implementations, one or more aspects of the process shown in FIGS. 1C and 1D may be performed by the computing system 100 described in relation to FIGS. 1A and 1B.

FIG. 1C depicts the initial stages of the process, focusing on data ingestion, processing, and knowledge graph construction. The computing system 100 includes an external data source 108B and an internal data source 108A, which provide input data to a data intake engine 114. In some implementations, the data intake engine 114 may be configured to obtain data from multiple sources, facilitating comprehensive analysis of both internal and external information.

The data intake engine 114 receives regulation data 138 from the external data source 108B and enterprise data 140 from the internal data source 108A. In some implementations, the regulation data 138 may include unstructured external data such as regulatory updates, industry standards, or compliance guidelines. The enterprise data 140 may include multi-modal unstructured enterprise data such as internal policies, process documents, or communication records.

The data intake engine 114 processes the incoming data to generate pre-processed data 142. In some implementations, the pre-processing may involve data cleaning, normalization, and initial structuring to prepare the information for further analysis. The pre-processed data 142 serves as input for subsequent stages of the dynamic data management process.

A datum extraction engine 122 receives the pre-processed data 142 and extracts sets of datum 144 from the input data. In some implementations, the datum extraction engine 122 may employ natural language processing techniques to identify and isolate relevant pieces of information from unstructured text, images, or other media formats. The datum 144 represents individual data points or atomic units of information extracted from the input sources.

The extracted datum 144 is provided to a data taxonomy engine 124, which generates a taxonomical structure 146 based on the processed information. In some implementations, the data taxonomy engine 124 may utilize machine learning algorithms to categorize information into hierarchical relationships, creating a coherent structure that reflects the relationships between different pieces of data.

The data taxonomy engine 124 organizes the information into a taxonomic data library 134. In some implementations, the taxonomic data library 134 may serve as a reference for categorizing new information and maintaining consistency in data classification across the organization. The taxonomic data library 134 may include a set of topic nodes, a set of sub-topic nodes, and a set of datum nodes, representing different levels of granularity in the taxonomical structure.

A knowledge graph engine 126 processes information from the taxonomic data library 134 to construct a knowledge graph 136. In some implementations, the knowledge graph engine 126 may create networks of interconnected nodes and edges, representing entities, concepts, and their relationships within the organization's data ecosystem. The knowledge graph 136 may facilitate complex queries, relationship discovery, and impact analysis when new information is introduced to the system.

A feedback component 132 connects to multiple parts of the system, including the taxonomic data library 134 and the data taxonomy engine 124. In some implementations, the feedback component 132 may collect user feedback on various aspects of the system's output, including the accuracy of inferred actions, the relevance of notifications, and the structure of the taxonomical data library. This feedback may be used to refine and update the machine learning models and algorithms used throughout the system.

In one implementation, the data flow illustrated in FIG. 1C may be applied to a cybersecurity organization managing threat intelligence and internal security protocols. The external data source 108B may provide regulation data 138 in the form of new guidelines from regulatory bodies such as the National Institute of Standards and Technology (NIST) or the Cybersecurity and Infrastructure Security Agency (CISA). This data may include unstructured text documents detailing updated requirements for vulnerability management or incident response procedures.

Simultaneously, the internal data source 108A may supply enterprise data 140, which may encompass a variety of formats including text documents, audio recordings of security team meetings, and video tutorials on current threat detection procedures. For instance, this data may include internal policy documents on network security protocols, recorded security training sessions, and flowcharts illustrating the current incident response workflow.

The data intake engine 114 may employ multimodal processing techniques to handle the diverse input formats. For textual data, it may use OCR to digitize any scanned documents. Audio data may be transcribed using speech-to-text algorithms, while video content may undergo both visual analysis and audio transcription. The data intake engine 114 may then normalize this data, standardizing date formats, reconciling terminology differences between regulatory and internal documents, and applying consistent metadata tagging.

The datum extraction engine 122 may utilize advanced NLP techniques to identify and extract relevant information from the pre-processed data 142. In some implementations, the datum extraction engine 122 may employ named entity recognition to identify key elements such as specific security requirements, implementation deadlines, or responsible security teams. The datum extraction engine 122 may also use semantic role labeling to understand the relationships between entities, such as which teams are responsible for implementing particular security measures.

To enhance the accuracy of datum extraction, the system may implement a retrieval augmented generation (RAG) architecture. This approach may allow the datum extraction engine 122 to query a vector store containing embeddings of the organization's historical documents, providing additional context for interpreting new information. For example, when processing a new NIST framework update on ransomware protection, the system may retrieve relevant context from previous internal documents on related procedures, enabling more accurate extraction of impacted processes and teams.

The data taxonomy engine 124 may then organize the extracted datum into a hierarchical structure. The data taxonomy engine 124 may employ unsupervised learning algorithms such as hierarchical clustering to identify natural groupings within the data. For instance, the data taxonomy engine 124 may create a top-level category for “Security Procedures,” with sub-categories for “Vulnerability Management,” “Incident Response,” and “Threat Detection.” Within these, the data taxonomy engine 124 may further categorize information by attributes such as “Regulatory Requirements,” “Internal Processes,” and “Responsible Teams.”

The knowledge graph engine 126 may then transform this taxonomical structure into a more flexible, interconnected representation. The knowledge graph engine 126 may use graph embedding techniques to generate vector representations of nodes and edges, facilitating efficient similarity computations and enabling advanced graph analytics capabilities. This may allow the system to quickly identify relationships between seemingly disparate pieces of information, such as how a new zero-day vulnerability mitigation requirement might impact endpoint security procedures in ways that might not be immediately apparent from the hierarchical taxonomy alone.

Throughout this process, the feedback component 132 may continually collect and incorporate user input to refine the system's performance. For example, security analysts reviewing the generated taxonomy may provide feedback on the categorization of certain threat intelligence requirements, which the system can use to adjust its classification algorithms. Similarly, feedback on the relationships identified in the knowledge graph may help tune the system's ability to infer indirect impacts of security framework changes across different departments.

FIG. 1D illustrates the subsequent stages of the dynamic data management process, focusing on the analysis of new data and the inference of appropriate actions. The computing system 100 continues to receive new data from the external data source 108B and the internal data source 108A. In some implementations, the new data 148 from the external data source 108B may include updated regulations or industry standards, while the new data 150 from the internal data source 108A may include updated process documents, policy documents, process guides, or policy guides.

The data intake engine 114 processes the incoming new data to generate new pre-processed data 152. In some implementations, this pre-processing step may involve similar techniques as those applied to the initial data ingestion, ensuring consistency in data handling throughout the system.

A scoring engine 128 receives the new pre-processed data 152 and interacts bidirectionally with the knowledge graph 136. In some implementations, the scoring engine 128 may be configured to analyze new data in the context of the existing taxonomized knowledge graph. This analysis may involve determining the relevance and potential impact of the new information on existing processes, policies, or organizational structures.

The scoring engine 128 outputs multiple indicators based on its analysis. These indicators include a severity type indication 154, which may classify the nature and urgency of the new information. The scoring engine 128 also generates a weighted severity score 156, which quantifies the importance of the new information based on various factors such as the source, scope, and potential consequences.

The weighted severity score 156 may incorporate multiple factors to provide a comprehensive assessment of the new information's importance and potential impact. In some implementations, the scoring engine 128 may calculate the weighted severity score 156 using predefined rules and/or machine learning algorithms. The weighted severity score 156 may take into account the source of the new information, assigning higher weights to data from authoritative or regulatory bodies. For instance, updates from government agencies or industry-specific regulatory authorities may receive a higher base score compared to internal policy changes. In some cases, the scoring engine 128 may analyze the content of the new data to determine its scope and potential consequences. This analysis may involve natural language processing techniques to identify key terms, phrases, or concepts that indicate the breadth of impact across different departments or processes within the organization.

The weighted severity score 156 may consider the urgency or time sensitivity of the new information. For example, regulatory changes with imminent deadlines may receive higher weights compared to long-term strategic updates. The scoring engine 128 may extract and interpret date-related information from the new data to factor this temporal aspect into the score calculation. In some implementations, the weighted severity score 156 may incorporate historical context by comparing the new information with previous updates stored in the knowledge graph 136. This comparison may help identify patterns or trends in regulatory changes, allowing the system to adjust the severity score based on the frequency or magnitude of changes in specific areas. The scoring engine 128 may consider the potential financial or operational impact of the new information when calculating the weighted severity score 156. This may involve analyzing the content for mentions of fines, penalties, or required operational changes, and estimating their potential cost or disruption to the organization.

In some aspects, the weighted severity score 156 may be dynamically adjusted based on feedback from users or the actual observed impact of previous updates. This adaptive approach may allow the system to fine-tune its scoring mechanism over time, improving the accuracy and relevance of the severity assessments. The weighted severity score 156 may be normalized to a specific range, such as 0 to 100 or 0 to 1, to facilitate easy interpretation and comparison across different types of updates. In some implementations, the scoring engine 128 may provide confidence intervals or uncertainty measures alongside the weighted severity score 156, reflecting the reliability of the assessment based on the available information.

Additionally, the scoring engine 128 produces an impact score 158, which estimates the extent of potential effects on existing processes or policies. In some implementations, the impact score 158 may be determined based on the taxonomized knowledge graph and the new data, considering factors such as the number of affected nodes in the knowledge graph or the depth of potential changes required.

The impact score 158 may provide a quantitative measure of the potential effects of new information on an organization's existing processes, policies, and structures. In some implementations, the impact score 158 may be calculated using graph analysis techniques and/or machine learning algorithms that evaluate the propagation of changes through the taxonomized knowledge graph. The scoring engine 128 may analyze the connectivity patterns within the knowledge graph to determine the reach of potential impacts. For instance, the scoring engine 128 may employ graph traversal algorithms to identify all nodes that are directly or indirectly connected to the nodes affected by the new information. The depth and breadth of these connections may contribute to the impact score calculation, with more extensive propagation resulting in a higher score.

In some cases, the impact score 158 may incorporate weighted factors based on the types of nodes and edges affected. For example, changes impacting core operational processes or critical compliance requirements may be assigned higher weights compared to those affecting peripheral or less frequently used procedures. The scoring engine 128 may consider the centrality measures of affected nodes, such as degree centrality or betweenness centrality, to assess their relative importance within the overall knowledge structure. The impact score 158 may take into account temporal factors, such as the time required to implement changes or the duration of potential disruptions. In some implementations, the scoring engine 128 may utilize predictive models trained on historical data to estimate the time and resources needed to address similar types of changes in the past.

To enhance the accuracy of the impact score 158, the system may incorporate domain-specific knowledge and heuristics. For instance, in a financial services context, the scoring engine 128 may apply predefined rules that reflect industry-specific dependencies between different compliance processes. This may allow for more nuanced impact assessments that consider the unique regulatory landscape and operational constraints of the organization. The impact score 158 may be presented alongside confidence intervals or probability distributions to reflect the level of certainty in the assessment. In some implementations, the scoring engine 128 may employ Monte Carlo simulations or other probabilistic techniques to model various scenarios and provide a range of potential impact outcomes.

To facilitate interpretation and decision-making, the impact score 158 may be normalized to a standardized scale, such as 1 to 10 or 0 to 100. The system may provide visual representations of the impact score, such as heat maps overlaid on the knowledge graph or radar charts showing impacts across different organizational dimensions. In some aspects, the calculation of the impact score 158 may be an iterative process. The scoring engine 128 may perform multiple passes through the knowledge graph, refining the impact assessment based on cascading effects and feedback loops identified during each iteration. This approach may help capture complex, non-linear impacts that might not be apparent from a single-pass analysis. The impact score 158 may be dynamically updated as new information becomes available or as the organization's knowledge graph evolves. In some implementations, the system may employ incremental learning techniques to continuously refine the impact scoring model based on observed outcomes and user feedback, improving its accuracy and relevance over time.

The scoring engine 128 also calculates an estimated cost 160 associated with addressing the implications of the new data. In some implementations, this cost estimation may consider factors such as required resources, time investments, or potential disruptions to existing operations. The estimated cost 160 may encompass a comprehensive evaluation of the financial and operational implications associated with addressing the new data. In some implementations, the scoring engine 128 may utilize machine learning algorithms to analyze historical data and predict the potential costs based on similar past scenarios. The estimated cost 160 may include both direct and indirect expenses, such as personnel hours, technology upgrades, training programs, and potential revenue impacts due to operational changes.

In some aspects, the system may break down the estimated cost 160 into different categories, such as immediate implementation costs, ongoing maintenance costs, and long-term strategic investment costs. This granular approach may allow organizations to better understand the financial implications across different time horizons and budget allocations. The scoring engine 128 may incorporate risk assessment techniques when calculating the estimated cost 160. In some implementations, the system may generate a range of cost estimates based on different risk scenarios, providing decision-makers with a spectrum of potential financial outcomes. This risk-adjusted approach may help organizations prepare for best-case, worst-case, and most likely cost scenarios.

In some cases, the estimated cost 160 may be dynamically linked to the impact score 158 and weighted severity score 156. As these scores are updated based on new information or feedback, the estimated cost 160 may automatically adjust to reflect the changing landscape of potential impacts and their associated expenses. The system may also consider opportunity costs when calculating the estimated cost 160. In some implementations, the scoring engine 128 may evaluate the potential benefits of implementing changes against the costs of inaction or delayed response. This analysis may help organizations prioritize their resource allocation and make informed decisions about which changes to address first. To enhance the accuracy of the estimated cost 160, the system may integrate with external data sources or industry benchmarks. In some aspects, the scoring engine 128 may compare the organization's estimated costs with industry averages or best practices, providing context for the financial implications of proposed changes.

The estimated cost 160 may be presented in various formats to suit different stakeholder needs. In some implementations, the system may generate detailed cost breakdowns, visual representations such as cost heat maps overlaid on the knowledge graph, or executive summaries highlighting key financial considerations. These diverse presentation options may facilitate effective communication of cost implications across different levels of the organization.

These indicators are provided to an action engine 130, which generates an action indication 162 based on the analyzed information. In some implementations, the action engine 130 may leverage the outputs from the scoring engine 128 and the knowledge graph 136 to infer appropriate actions based on the new data. The action indication 162 may include recommendations for updating documents, notifying specific teams, or initiating new processes based on the analyzed information.

The action engine 130 may employ inference techniques to determine an appropriate action based on the analyzed information. In some implementations, the action engine 130 may utilize rule-based approaches, machine learning approaches, or a combination thereof to process the outputs from the scoring engine 128 and the knowledge graph 136. This hybrid approach may allow for both predefined logic and adaptive decision-making capabilities.

The inference process may involve multiple stages of analysis. Initially, the action engine 130 may categorize the new data and its potential impacts into predefined action categories, such as document updates, team notifications, process initiations, or escalations to higher-level decision-makers. This categorization may be based on the weighted severity score 156, impact score 158, and estimated cost 160 provided by the scoring engine 128. In some cases, the action engine 130 may employ a decision tree or random forest algorithm to map different combinations of scores and graph properties to specific action categories. These machine learning models may be trained on historical data of past actions taken in response to similar situations, allowing the system to learn from previous decision-making patterns.

The action engine 130 may incorporate natural language generation techniques to produce human-readable summaries of its recommendations. In some implementations, these summaries may be tailored to different stakeholder groups within the organization, adjusting the level of detail and technical language based on the intended audience. To enhance the accuracy and relevance of its inferences, the action engine 130 may implement a contextual analysis component. This component may consider factors such as the current organizational structure, ongoing projects or initiatives, and recent actions taken in related areas. By incorporating this contextual information, the action engine 130 may generate more nuanced and situationally appropriate action recommendations.

In some aspects, the action engine 130 may utilize reinforcement learning techniques to optimize its decision-making process over time. The system may learn from the outcomes of previous actions and adjust its recommendations accordingly. This adaptive approach may help improve the effectiveness of the inferred actions and align them more closely with the organization's goals and constraints. The action engine 130 may incorporate a prioritization mechanism that balances the urgency of actions against available resources and potential conflicts with ongoing initiatives. This may involve generating a prioritized list of recommended actions, taking into account factors such as regulatory deadlines, resource availability, and potential synergies or conflicts with other ongoing changes.

In some implementations, the action engine 130 may leverage advanced natural language processing techniques to enhance its inference capabilities. For example, the system may employ RAG architecture to query a vector store containing embeddings of the organization's historical documents. This approach may provide additional context for interpreting new information and inferring appropriate actions.

The action engine 130 may utilize an agentic framework to refine its action recommendations. In this approach, an initial set of recommendations may be generated and then passed to a reflection agent for feedback. This feedback may be used to iteratively improve the recommendations, potentially increasing their accuracy and relevance. To address the challenge of information overload, the action engine 130 may implement intelligent notification strategies. For lower-impact changes, the system may batch notifications and deliver them at regular intervals, such as weekly summaries. Higher-impact changes may trigger immediate, targeted notifications to relevant stakeholders.

In some cases, the action engine 130 may interface with other enterprise systems to facilitate the execution of inferred actions. For example, the action engine 130 may integrate with document management systems to initiate version control processes for policy updates, or with communication platforms to send targeted notifications to relevant team members.

The action engine 130 may maintain an audit trail of recommended actions and their outcomes, providing data for compliance reporting and continuous improvement of the system's decision-making capabilities. This historical record may also be used to identify patterns in organizational responses to different types of changes, further refining the inference process.

The action indication 162 connects to a feedback component 132, which receives inputs from both the action indication 162 and a data taxonomy 164. In some implementations, the data taxonomy 164 may represent an updated version of the taxonomical structure that incorporates the new information. The feedback component 132 may collect user feedback on the inferred actions and the updated taxonomy, using this input to refine the system's decision-making processes. The feedback component 132 provides feedback to the knowledge graph 136, creating a feedback loop within the system. In some implementations, this feedback mechanism may allow for continuous improvement of the knowledge graph structure and the accuracy of inferred actions over time.

Throughout this process, the computing system 100 employs a machine learning component to perform various tasks. In some implementations, the machine learning component may include a generative artificial intelligence component, which may be used for generating the taxonomical data structure, constructing the taxonomized knowledge graph, and inferring actions based on new data.

In some implementations, the system may perform additional operations to enhance the accuracy and reliability of its outputs. For example, the system may perform, based on a connected external data source, at least one of a fact checking operation or a verification operation associated with the new data. This may help ensure the validity and consistency of the information being processed and acted upon.

In some implementations, the system 100 may automatically perform an inferred action based on the analysis of new data and the existing knowledge graph. For example, when the action engine 130 determines that a high-impact regulatory change requires immediate attention, the system may automatically initiate the process of updating relevant policy documents. This may involve the system accessing the document management system, creating new versions of affected policies, and applying the necessary changes based on the inferred action. The system may utilize natural language generation techniques to draft specific updates to the policy language, ensuring compliance with the new regulatory requirements.

In cases where the inferred action involves notifying multiple teams about a significant change, the system 100 may automatically generate and distribute targeted communications. For instance, if a new KYC regulation affects both the onboarding and transaction monitoring processes, the system may create customized notifications for each impacted team. These notifications may include details about the specific changes required in their respective procedures, potential impacts on their workflows, and deadlines for implementation. The system may leverage the organization's communication platforms, such as email systems or collaboration tools, to deliver these notifications directly to the relevant stakeholders.

Furthermore, the system 100 may automatically trigger workflow updates in response to inferred actions. For example, if a change in Anti-Money Laundering (AML) procedures requires additional steps in the customer screening process, the system may interface with workflow management tools to modify existing process flows. This may involve adding new tasks, adjusting decision points, or updating automated rules within the workflow engine. By automatically implementing these changes, the system helps ensure that operational processes are quickly aligned with new requirements, reducing the risk of non-compliance and minimizing the manual effort required to update complex workflows.

Continuing from the cybersecurity example described above in connection with FIG. 1C, the system may process new regulatory data related to vulnerability management practices. For instance, the external data source 108B may provide a new guideline from the NIST regarding enhanced vulnerability scanning procedures for cloud-based infrastructure. Simultaneously, the internal data source 108A may supply updated internal policies on security patch management procedures.

The data intake engine 114 may process this new information, applying natural language processing techniques to extract key elements from both the NIST guideline and the internal policy update. The resulting new pre-processed data 152 may include structured representations of the new requirements, such as specific scanning frequencies for different asset types, required timeframes for patch implementation, and new categories of critical vulnerabilities requiring expedited remediation.

The scoring engine 128 may then analyze this new pre-processed data 152 in the context of the existing knowledge graph 136. By traversing the graph, the scoring engine 128 may identify nodes and relationships related to current vulnerability management practices, patch deployment procedures, and risk assessment methodologies. Based on this analysis, the scoring engine 128 may generate multiple indicators. The severity type indication 154 may classify the NIST guideline as a “Critical Security Framework Update” and the internal policy change as a “Major Security Process Modification.” The weighted severity score 156 may be calculated based on factors such as the authoritative nature of NIST, the scope of affected security processes, and the deadline for implementation. For example, the NIST guideline may receive a high weighted severity score of 0.88 on a scale of 0 to 1. The impact score 158 may be determined by assessing the number of affected nodes in the knowledge graph and the depth of required changes. In this case, the impact score may be 0.75, indicating significant effects across multiple security teams and infrastructure components. The estimated cost 160 may be calculated based on historical data of similar security framework implementations, considering factors such as required scanning tool upgrades, staff training, and potential increases in security analyst workload. The system may estimate a range of costs, such as $350,000 to $600,000 for full implementation.

These indicators may then be passed to the action engine 130, which may generate an action indication 162 recommending a series of steps:
1. Immediate notification to the Security Operations, Infrastructure, and DevOps teams about the new NIST guideline.
2. Initiation of a gap analysis between current vulnerability management practices and new requirements.
3. Scheduling of cross-team meetings to plan the implementation strategy for enhanced scanning procedures.
4. Creation of a project timeline for updating relevant security policies, scanning configurations, and remediation workflows.
5. Development of a training program for security analysts and system administrators on the new vulnerability management requirements.

The action indication 162 and the updated data taxonomy 164 reflecting the new security requirements may be sent to the feedback component 132. This component may then present the proposed actions and taxonomical changes to relevant security stakeholders for review and input. The feedback received may be used to refine the action recommendations and update the knowledge graph 136, ensuring that the system's understanding of the organization's vulnerability management practices remains current and accurate.

The dynamic data management process illustrated in FIGS. 1C and 1D enables organizations to efficiently analyze new information against their current state policies and procedures, assess the impact of changes, and take action on at-risk or non-compliant items. By leveraging advanced machine learning techniques and a comprehensive knowledge graph structure, the system can provide timely, relevant, and actionable insights to support decision-making and maintain regulatory compliance.

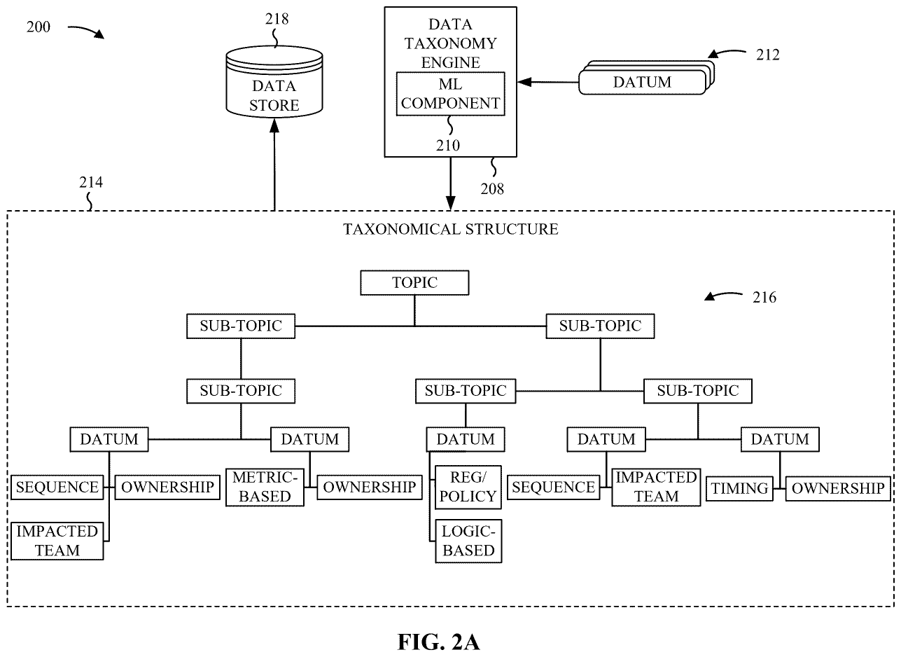

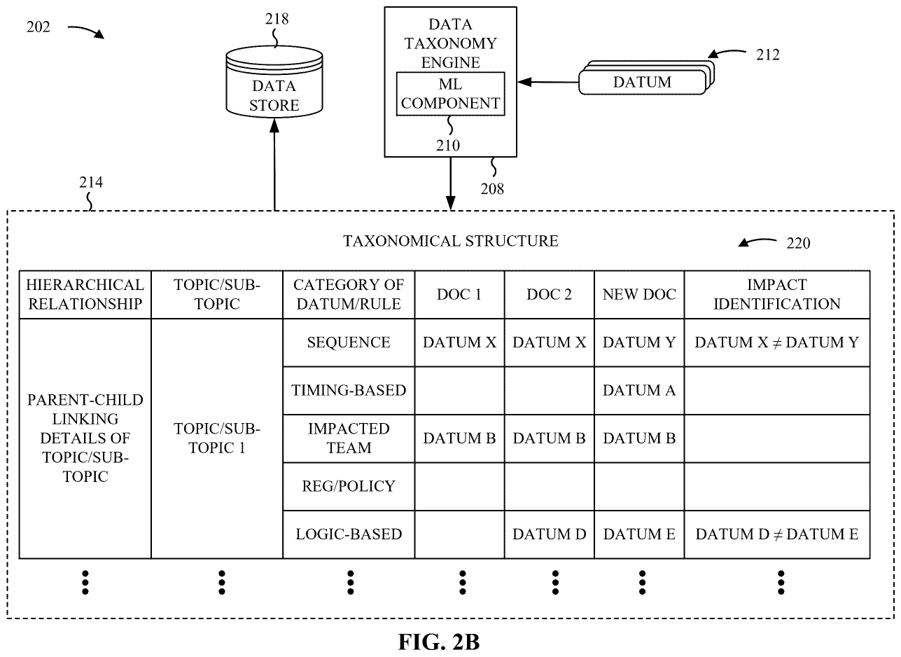

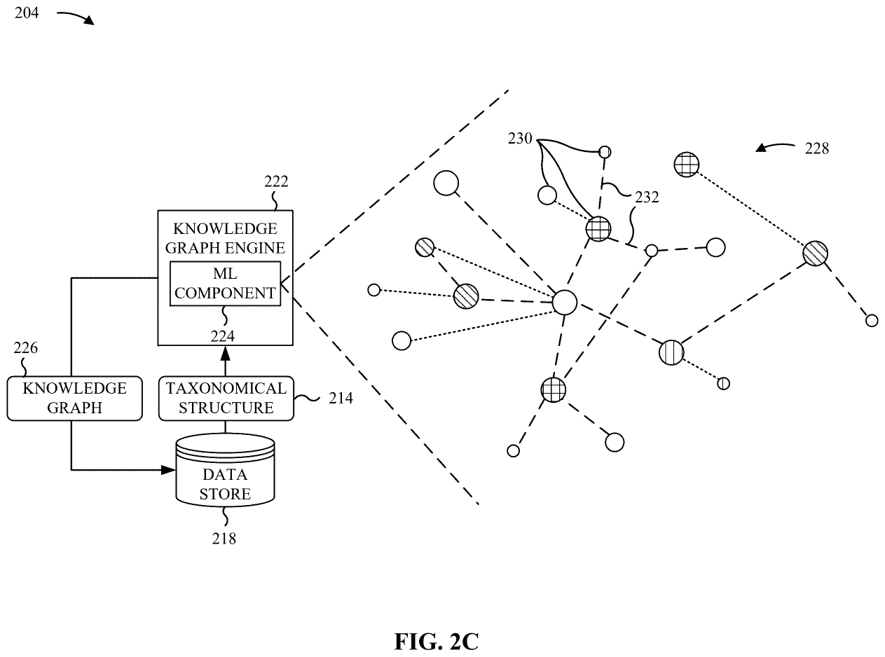

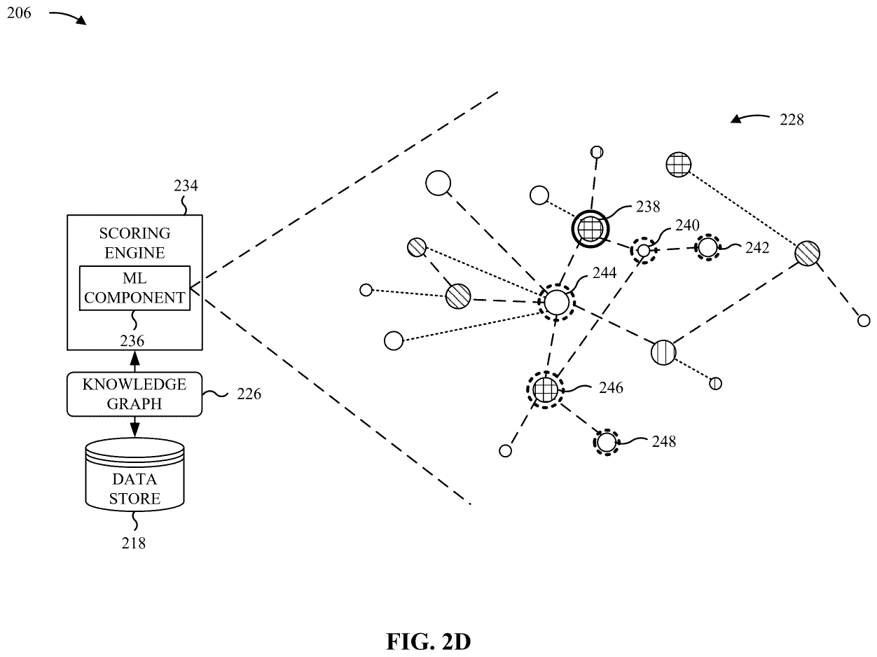

FIGS. 2A-2D are diagrams illustrating examples of processes for dynamic data management using taxonomized knowledge graphs. In some implementations, one or more aspects of the processes shown in FIGS. 2A-2D may be performed by the computing system 100 described in relation to FIGS. 1A-1D.

FIG. 2A depicts an example 200 of a process for generating a taxonomical data structure. The process includes a data taxonomy engine 208 that may be configured to receive datum 212 as input. In some implementations, the data taxonomy engine 208 may include an ML component 210 that may be configured to process the input datum 212. The ML component 210 may facilitate the analysis and categorization of the datum 212 into a hierarchical structure.

The data taxonomy engine 208 may be configured to generate a taxonomical structure 214 based on the processed information. In some implementations, the taxonomical structure 214 may organize topics into a hierarchical arrangement, with a main topic node at the top level that branches into multiple sub-topic nodes at lower levels. The sub-topic nodes may further branch into additional sub-topic nodes, creating multiple levels within the structure.

At the lowest level of the taxonomical structure 214, datum nodes may connect to their respective sub-topics. The datum nodes may include various categories of information such as sequence, ownership, metric-based data, and other attributes. These datum nodes may be connected by edges that represent relationships like “impacted team,” “ownership,” “timing,” and other classifications.

The data taxonomy engine 208 may employ NLP techniques to analyze and categorize the input datum 212. In some implementations, the data taxonomy engine 208 may utilize named entity recognition to identify key concepts, entities, and relationships within the data. For example, when processing financial compliance documents, the data taxonomy engine 208 may recognize entities such as “transaction thresholds,” “reporting deadlines,” or “regulatory bodies.” The data taxonomy engine 208 may also implement sentiment analysis to gauge the tone and importance of different pieces of information, which may be particularly useful when categorizing internal policy documents or external regulatory guidance.

In some aspects, the data taxonomy engine 208 may incorporate machine learning algorithms that can adapt and improve its categorization capabilities over time. For instance, the data taxonomy engine 208 may use supervised learning techniques, where it learns from a set of pre-labeled data to improve its classification accuracy. As the system processes more data and receives feedback from users, it may refine its categorization rules and adjust the taxonomical structure 214 accordingly. The data taxonomy engine 208 may employ unsupervised learning methods, such as clustering algorithms, to discover latent patterns and relationships within the data that may not be immediately apparent to human analysts.

The data taxonomy engine 208 may support multi-lingual and cross-domain categorization capabilities. In some implementations, the engine may use transfer learning techniques to apply knowledge gained from categorizing data in one domain or language to improve its performance in another. For example, insights gained from categorizing financial regulations in English may be applied to help categorize similar documents in other languages or in adjacent regulatory domains. The data taxonomy engine 208 may incorporate domain-specific ontologies and knowledge bases to enhance its understanding of specialized terminology and concepts, allowing for more accurate and nuanced categorization of complex technical or legal documents.

The data taxonomy engine 208 may incorporate several advanced techniques to enhance the accuracy and efficiency of datum extraction from the company's documents. In some implementations, the engine may utilize an RAG architecture to provide additional context when extracting datum. This approach may involve chunking and embedding all of the company's documents into a vector store, creating a vast set of contextual information. When extracting datum from a specific document, the system may query the vector store to retrieve only the most relevant context, potentially improving the understanding of company-specific terminology and concepts.

In some aspects, the data taxonomy engine 208 may employ fine-tuning techniques to optimize its performance. By fine-tuning the underlying language model on all company documents and relevant publicly available documents in the same industry, the system may increase its accuracy while potentially reducing the size of the language model required for the task. This approach may allow for more efficient processing of domain-specific information and terminology.

The data taxonomy engine 208 may implement an agentic framework to further refine its datum extraction capabilities. In some implementations, this may involve a reflection architecture where an initial output is created by an original agent and then passed to a reflection agent for feedback. This feedback may be used to iteratively improve the response, potentially increasing the accuracy and quality of the extracted datum. The system may repeat this loop until a satisfactory response is achieved.

In some cases, the data taxonomy engine 208 may incorporate a research component within its agentic framework. This component may extract search terms and concepts from the original document and use them to pull publicly available information from the web. This additional context may be integrated into the datum extraction process, potentially enhancing the system's understanding of complex or evolving topics.

By combining these advanced techniques, the data taxonomy engine 208 may adapt to the specific needs and context of the organization, potentially improving its ability to accurately extract and categorize relevant information from diverse document sources.

The process may include a data store 218 that may be configured to provide storage for the taxonomical structure 214 and related data. In some implementations, the data store 218 may facilitate efficient retrieval and updating of the taxonomical information.

FIG. 2B illustrates another example of a representation 220 of the taxonomical structure 214. The taxonomical structure 214 may organize information into hierarchical categories including hierarchical relationships, topic/sub-topic classifications, and categories of datum/rules. In some implementations, the representation 220 may include columns for hierarchical relationships, topic/sub-topic information, category of datum/rule, document identifiers (DOC 1, DOC 2, NEW DOC), and impact identification. The representation 220 may display various datum entries organized by sequence, timing-based information, impacted team data, regulatory/policy information, and logic-based relationships.

In some implementations, the representation 220 may use a tabular format to display the hierarchical relationships between different levels of information, from broad topics down to specific datum points. This layout may allow users to easily trace the lineage of any given piece of information, understanding its context within the larger organizational structure.

The representation 220 may also showcase the system's ability to track changes and impacts across different documents or versions. By including columns for multiple document identifiers (DOC 1, DOC 2, NEW DOC), the representation 220 may enable users to compare how specific datum or rules have evolved over time or across different sources. This feature may be particularly useful for identifying discrepancies between documents or tracking the implementation of new policies or regulations. The impact identification column may further enhance this functionality by highlighting the potential consequences of changes, allowing stakeholders to quickly assess the scope and significance of any modifications to the taxonomical structure.

In some aspects, the representation 220 may incorporate color coding, icons, or other visual cues to enhance the readability and interpretation of the displayed information. For example, different categories of datum or rules may be associated with distinct colors or symbols, making it easier for users to quickly identify and categorize information at a glance. The representation 220 may also include interactive elements, allowing users to expand or collapse different levels of the hierarchy, filter information based on specific criteria, or drill down into particular datum points for more detailed information. This interactivity may enhance the usability of the representation 220, enabling users to efficiently navigate and analyze the complex taxonomical structure 214.

The data taxonomy engine 208 may be configured to process information between the data store 218 and the taxonomical structure 214, which may facilitate dynamic updates and maintenance of the organized data relationships. In some implementations, the ML component 210 may enable automated analysis and classification of new datum 212 as it is incorporated into the existing taxonomical framework.

FIG. 2C depicts an example 204 of a process for constructing a taxonomized knowledge graph. The process includes a knowledge graph engine 222 and an ML component 224 that may be configured to generate a knowledge graph 226 based on a taxonomical structure 214 stored in a data store 218.

In some implementations, the knowledge graph engine 222 may be configured to process the taxonomical structure 214 to create the knowledge graph 226, which may include nodes 230 connected by edges 232. The ML component 224 may facilitate the analysis of relationships between elements of the taxonomical structure 214 to determine appropriate connections in the knowledge graph 226.

The system may generate a representation 228 of the knowledge graph 226 that may visually depict the nodes 230 and edges 232 showing the relationships and connections between different elements. In some implementations, the example 204 may demonstrate how the taxonomical structure 214 is transformed into an interconnected knowledge graph representation. The nodes 230 may represent topics and subtopics from the taxonomical structure 214, while the edges 232 may represent relationships and connections between those topics. In some implementations, the knowledge graph engine 222 may work in conjunction with the ML component 224 to analyze the taxonomical structure 214 and establish these relationships in the knowledge graph 226.

In some implementations, the knowledge graph engine 222 may employ a multi-stage process to construct the knowledge graph 226 from the taxonomical structure 214. The engine may first identify key entities within the taxonomical structure, such as main topics, subtopics, and individual datum points. These entities may be transformed into nodes 230 within the knowledge graph 226. The knowledge graph engine 222 may then analyze the hierarchical relationships and classifications present in the taxonomical structure 214 to establish initial connections between the nodes, creating a basic skeleton of the knowledge graph.

The ML component 224 may facilitate enhancing the knowledge graph construction process. It may analyze the content and context of each node to infer additional relationships that may not be explicitly defined in the taxonomical structure 214. For example, the ML component 224 may identify semantic similarities between different topics or subtopics, even if they are not directly connected in the original hierarchy. These inferred relationships may be represented as new edges 232 in the knowledge graph 226, enriching the network of connections. The ML component 224 may also assign weights or confidence scores to the edges, reflecting the strength or reliability of each relationship.

In some aspects, the knowledge graph construction process may be iterative and dynamic. As new information is added to the taxonomical structure 214, the knowledge graph engine 222 may continuously update the knowledge graph 226. This may involve adding new nodes, creating new edges, or modifying existing relationships based on the latest data. The system may also incorporate feedback mechanisms, allowing users to validate or refine the connections within the knowledge graph. This feedback may be used to train and improve the ML component 224, potentially enhancing its ability to accurately infer relationships in future iterations of the knowledge graph construction process.

In some implementations, the knowledge graph 226 may utilize various properties of the graph structure to represent different types of datum and relationships. The nodes 230 may be assigned attributes that correspond to specific characteristics of the datum they represent, such as data type, source, timestamp, or confidence level. The edges 232 connecting these nodes may be weighted to indicate the strength or importance of the relationship, with higher weights potentially signifying more significant connections. In some cases, the directionality of edges may be used to represent hierarchical relationships or causal links between datum points. The system may also employ different node shapes or sizes to visually distinguish between various categories of information, such as using larger nodes for main topics and smaller nodes for specific data points. Additionally, the knowledge graph 226 may incorporate hyperedges, which can connect multiple nodes simultaneously, to represent complex relationships that involve more than two entities. This rich set of graph properties may allow the system to capture and represent nuanced information structures, potentially enabling more sophisticated analysis and inference capabilities.

In some implementations, the knowledge graph 226 may be stored using specialized graph database systems optimized for efficient storage, retrieval, and traversal of interconnected data. These graph databases may utilize data structures such as adjacency lists, adjacency matrices, or more advanced representations like property graphs to model nodes 230 and edges 232. The system may employ indexing techniques—such as B-tree or hash-based indexes—to enhance query performance, enabling rapid lookup of nodes and edges based on attributes or relationships.

The knowledge graph may be accessed and manipulated via graph-specific query languages or APIs that support complex traversals and pattern matching. In some aspects, in-memory graph processing techniques may be employed to accelerate computations on frequently accessed subgraphs. To support scalability, the graph may be partitioned across multiple storage nodes, enabling distributed execution of graph algorithms and queries. Additionally, versioning mechanisms may be incorporated to support temporal analysis and rollback to prior states of the graph structure.

FIG. 2D illustrates an example 206 of a process for scoring and analyzing new data using the taxonomized knowledge graph. The process includes a scoring engine 234 connected to a data store 218. In some implementations, the scoring engine 234 may include an ML component 236 that may be configured to process information from a knowledge graph 226.

The knowledge graph 226 may include multiple interconnected nodes, including a changed node 238 and several impacted nodes 240, 242, 244, 246, and 248. In some implementations, the nodes may be connected through various types of edges represented by different line styles (dashed, dotted, and solid lines), indicating different relationships between the nodes.

The scoring engine 234 may be configured to analyze the knowledge graph 226 to determine impacts and relationships between the nodes. In some implementations, the ML component 236 may process this information to evaluate changes and impacts across the connected nodes. The system may generate a representation 228 based on the analysis performed by the scoring engine 234.

The data store 218 may connect to the knowledge graph 226, which may facilitate storage and retrieval capabilities for the graph data and associated information. In some implementations, the various connections between nodes may illustrate how changes to one node can affect multiple other nodes throughout the knowledge graph structure.

In some implementations, the processes illustrated in FIGS. 2A-2D may work together to create a comprehensive system for dynamic data management using taxonomized knowledge graphs. The taxonomical data structure generated in FIG. 2A may serve as the foundation for organizing multi-modal unstructured enterprise data and unstructured external data. This structure may then be used to construct the taxonomized knowledge graph as shown in FIG. 2C.

When new data is obtained from an external data source or an internal data source, the scoring engine depicted in FIG. 2D may analyze this data in the context of the existing knowledge graph. This analysis may facilitate the inference of appropriate actions associated with the new data, which may be based on factors such as impact scores, severity scores, and estimated costs.

The system may determine, based on the taxonomized knowledge graph and the new data, at least one impacted team associated with the new data. Additionally, the system may determine an impact score associated with the new data, which may be used in inferring the appropriate action. In some implementations, the system may determine a set of candidate actions based on the new data and the taxonomical data structure. The system may also determine a set of estimated costs associated with the set of candidate actions, which may be used in inferring the most appropriate action.

The system may output library data configured to cause a computing device to present a representation of a taxonomical data library based on the taxonomical data structure. In some implementations, the system may receive, via the computing device, a set of user feedback associated with the representation of the taxonomical data library. This feedback may be used to update the machine learning component, continually improving the system's performance. Similarly, the system may output severity score data configured to cause a computing device to present a representation of a weighted severity score associated with the new data. User feedback on this representation may also be used to refine the machine learning component. In some implementations, the system may perform, based on a connected external data source, at least one of a fact checking operation or a verification operation associated with the new data. This may help ensure the accuracy and reliability of the inferred actions.

The processes illustrated in FIGS. 2A-2D may facilitate efficient analysis of new information against current state policies and procedures, assessment of the impact of changes, and action on at-risk or non-compliant items. By leveraging advanced machine learning techniques and a comprehensive knowledge graph structure, the system may provide timely, relevant, and actionable insights to support decision-making and maintain regulatory compliance.

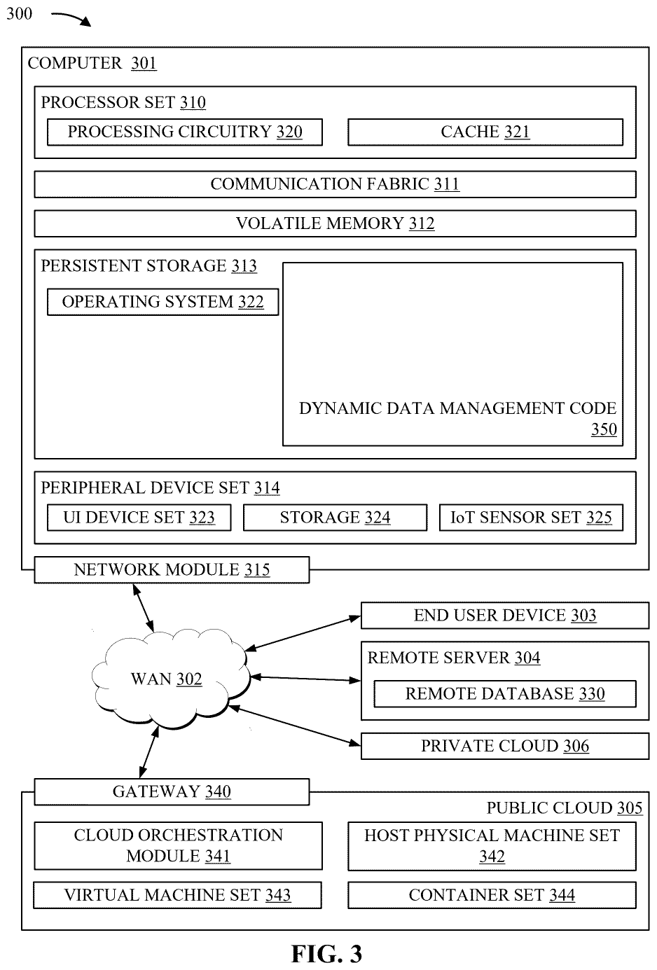

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 300 contains an example of an environment for the execution of at least some of the computer code involved in performing the inventive methods, such as dynamic data management code, shown in block 350. In addition to block 350, the computing environment 300 includes, for example, a computer 301, a wide area network (WAN) 302, an end user device (EUD) 303, a remote server 304, a public cloud 305, and a private cloud 306. In this embodiment, the computer 301 includes a processor set 310 (including processing circuitry 320 and a cache 321), a communication fabric 311, a volatile memory 312, persistent storage 313 (including an operating system 322 and a block 350, as identified above), a peripheral device set 314 (including a user interface (UI) device set 323, storage 324, and an Internet of Things (IoT) sensor set 325), and a network module 315. The remote server 304 includes a remote database 330. The public cloud 305 includes a gateway 340, a cloud orchestration module 341, a host physical machine set 342, a virtual machine set 343, and a container set 344.

The computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 330. As is well understood in the art of computer technology, and depending upon the technology, performance of a computer-implemented method may be distributed among multiple computers and/or between multiple locations. On the other hand, in this presentation of the computing environment 300, detailed discussion is focused on a single computer, specifically the computer 301, to keep the presentation as simple as possible. The computer 301 may be located in a cloud, even though it is not shown in a cloud in FIG. 3. On the other hand, the computer 301 is not required to be in a cloud except to any extent as may be affirmatively indicated.

The processor set 310 includes one or more computer processors of any type now known or to be developed in the future. The processing circuitry 320 may be distributed over multiple packages, for example, multiple, coordinated integrated circuit chips. The processing circuitry 320 may implement multiple processor threads and/or multiple processor cores. The cache 321 is memory that is located in the processor chip package(s) and is typically used for data or code that should be available for rapid access by the threads or cores running on the processor set 310. Cache memories are typically organized into multiple levels depending upon relative proximity to the processing circuitry. Alternatively, some, or all, of the cache for the processor set may be located “off chip.” In some computing environments, the processor set 310 may be designed for working with qubits and performing quantum computing.

Computer readable program instructions are typically loaded onto the computer 301 to cause a series of operational steps to be performed by the processor set 310 of the computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 321 and the other storage media discussed below. The program instructions, and associated data, are accessed by the processor set 310 to control and direct performance of the inventive methods. In the computing environment 300, at least some of the instructions for performing the inventive methods may be stored in the block 350 in persistent storage 313.

The communication fabric 311 is the signal conduction path that allows the various components of the computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 312 is any type of volatile memory now known or to be developed in the future. Examples include dynamic type RAM or static type RAM. Typically, the volatile memory 312 is characterized by random access, but this is not required unless affirmatively indicated. In the computer 301, the volatile memory 312 is located in a single package and is internal to the computer 301, but, alternatively or additionally, the volatile memory 312 may be distributed over multiple packages and/or located externally with respect to the computer 301.

The persistent storage 313 is any form of non-volatile storage for computers that is now known or to be developed in the future. The non-volatility of this storage means that the stored data is maintained regardless of whether power is being supplied to the computer 301 and/or directly to the persistent storage 313. The persistent storage 313 may be an ROM, but typically at least a portion of the persistent storage allows writing of data, deletion of data and re-writing of data. Some familiar forms of persistent storage include magnetic disks and solid state storage devices. The operating system 322 may take several forms, such as various known proprietary operating systems or open source Portable Operating System Interface-type operating systems that employ a kernel. The code included in block 350 typically includes at least some of the computer code involved in performing the inventive methods.

The peripheral device set 314 includes the set of peripheral devices of the computer 301. Data communication connections between the peripheral devices and the other components of the computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 323 may include components such as a display screen, speaker, microphone, wearable devices (such as goggles and smart watches), keyboard, mouse, printer, touchpad, game controllers, and haptic devices. The storage 324 is external storage, such as an external hard drive, or insertable storage, such as an SD card. The storage 324 may be persistent and/or volatile. In some embodiments, the storage 324 may take the form of a quantum computing storage device for storing data in the form of qubits. In embodiments where the computer 301 is required to have a large amount of storage (for example, where the computer 301 locally stores and manages a large database) then this storage may be provided by peripheral storage devices designed for storing very large amounts of data, such as a storage area network (SAN) that is shared by multiple, geographically distributed computers. The IoT sensor set 325 is made up of sensors that can be used in Internet of Things applications. For example, one sensor may be a thermometer and another sensor may be a motion detector.

The network module 315 is the collection of computer software, hardware, and firmware that allows the computer 301 to communicate with other computers through the WAN 302. The network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 315 are performed on the same physical hardware device. In other embodiments (for example, embodiments that utilize software-defined networking (SDN)), the control functions and the forwarding functions of the network module 315 are performed on physically separate devices, such that the control functions manage several different network hardware devices. Computer readable program instructions for performing the inventive methods can typically be downloaded to the computer 301 from an external computer or external storage device through a network adapter card or network interface included in the network module 315.

The WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The EUD 303 is any computer system that is used and controlled by an end user (for example, a customer of an enterprise that operates the computer 301) and may take any of the forms discussed above in connection with the computer 301. The EUD 303 typically receives helpful and useful data from the operations of computer 301. For example, in a hypothetical case where the computer 301 is designed to provide a recommendation to an end user, this recommendation would typically be communicated from the network module 315 of the computer 301 through the WAN 302 to the EUD 303. In this way, the EUD 303 can display, or otherwise present, the recommendation to an end user. In some embodiments, the EUD 303 may be a client device, such as thin client, heavy client, mainframe computer, desktop computer and so on.

The remote server 304 is any computer system that serves at least some data and/or functionality to the computer 301. The remote server 304 may be controlled and used by the same entity that operates the computer 301. The remote server 304 represents the machine(s) that collect and store helpful and useful data for use by other computers, such as the computer 301. For example, in a hypothetical case where the computer 301 is designed and programmed to provide a recommendation based on historical data, then this historical data may be provided to the computer 301 from the remote database 330 of the remote server 304.

The public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 305 is performed by the computer hardware and/or software of the cloud orchestration module 341. The computing resources provided by the public cloud 305 are typically implemented by virtual computing environments that run on various computers making up the computers of the host physical machine set 342, which is the universe of physical computers in and/or available to the public cloud 305. The virtual computing environments (VCEs) typically take the form of virtual machines from the virtual machine set 343 and/or containers from the container set 344. It is understood that these VCEs may be stored as images and may be transferred among and between the various physical machine hosts, either as images or after instantiation of the VCE. The cloud orchestration module 341 manages the transfer and storage of images, deploys new instantiations of VCEs and manages active instantiations of VCE deployments. The gateway 340 is the collection of computer software, hardware, and firmware that allows the public cloud 305 to communicate through the WAN 302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 306 is similar to the public cloud 305, except that the computing resources are only available for use by a single enterprise. While the private cloud 306 is depicted as being in communication with the WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 305 and the private cloud 306 are both part of a larger hybrid cloud.

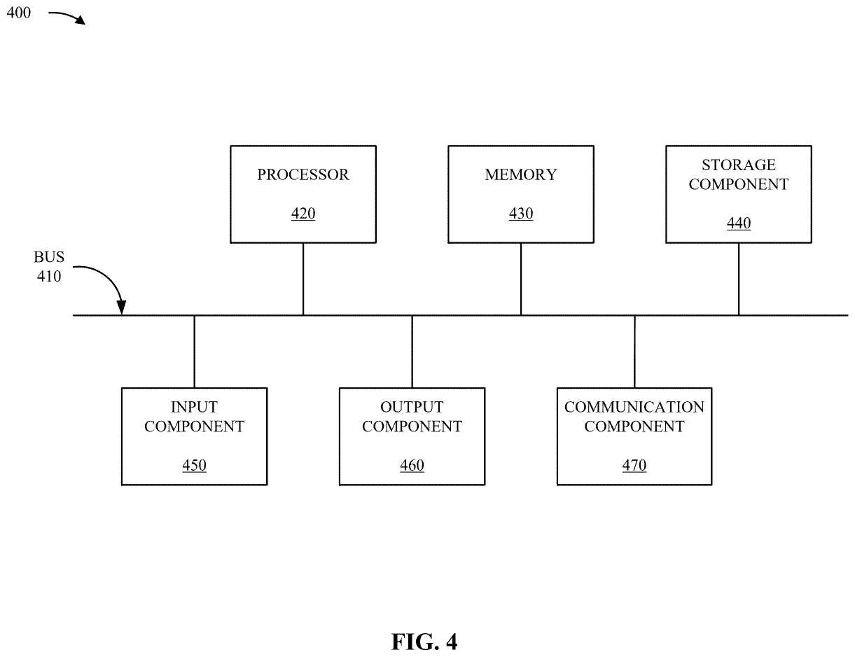

FIG. 4 is a diagram of example components of a device 400, which may implement one or more components of the computing environment 100. In some implementations, the device 400 may be, be similar to, include, or be included in the computer 301 shown in FIG. 3. The device 400 may be, be similar to, include, or be included in, an apparatus for performing one or more methods, processes, algorithms, operations, tasks, and/or techniques, as described herein. The device 400 may be, be similar to, include, or be included in, a computing device, a laptop, a workstation, a server device, or a personal computer, among other examples. As shown in FIG. 4, device 400 may include a bus 410 that interconnects various components or units, such as a processor 420, a memory 430, a storage component 440, an input component 450, an output component 460, and a communication component 470.

The processor 420 may be a central processing unit, such as a microprocessor, and may include single or multiple processors having single or multiple processing cores. The processor 420 may include another type of device, or multiple devices, configured for manipulating or processing information. For example, the processor 420 may include multiple processors interconnected in one or more manners, including hardwired or networked. The operations of the processor 420 may be distributed across multiple devices or units that can be coupled directly or across a local area or other suitable type of network. The processor 420 may include a cache, or cache memory, for local storage of operating data or instructions. The processor 420 is implemented in hardware, firmware, or a combination of hardware and software. In some implementations, the processor 420 includes one or more processors capable of being programmed to perform a function. In some implementations, the processor 420 may be, be similar to, include, or be included in processor set 310 shown in FIG. 3.

The memory 430 includes one or more memory components, which may each be volatile memory or non-volatile memory. The memory 430 may include non-transitory memory. The volatile memory can be RAM (e.g., a DRAM module, such as DDR SDRAM). The non-volatile memory of the memory 430 may be a disk drive, a solid state drive, flash memory, or phase-change memory. In some implementations, the memory 430 may be distributed across multiple devices. For example, the memory 430 may include network-based memory or memory in multiple clients or servers performing the operations of those multiple devices.

The memory 430 may include data for access by the processor 420. For example, the memory 206 may include executable instructions, application data, or an operating system, among other examples. The executable instructions may include one or more application programs, which may be loaded or copied, in whole or in part, from non-volatile memory to volatile memory to be executed by the processor 420. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 440 stores information and/or software related to the operation of the device 400. For example, the storage component 440 may include a hard disk drive, a magnetic disk drive, an optical disk drive, a solid state disk drive, a compact disc, a digital versatile disc, and/or another type of non-transitory computer-readable medium. The storage component 440 may be, be similar to, include, or be included in, the memory 430.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 3 and 4, such as a single processor or a combination of multiple different processors. Reference to “one or more processors” should be understood to refer to any one or more of the processors described in connection with FIGS. 3 and 4.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 3 and 4. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

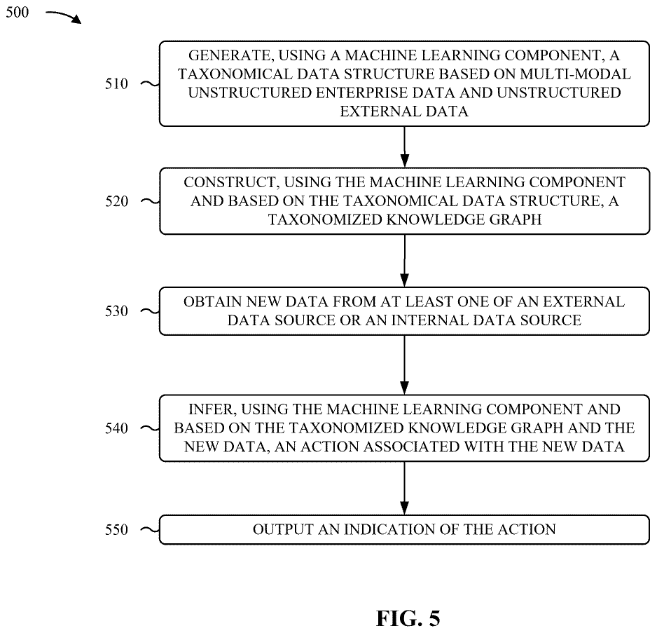

To further describe some implementations in greater detail, reference is next made to examples of techniques which may be performed by or using an AI system as described herein. FIG. 5 is a flowchart of an example of a technique 500 associated with dynamic data management using taxonomized knowledge graphs. The technique 500 can be executed using computing devices, such as the systems, hardware, and software described with respect to FIGS. 1A-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations of the technique 500 can occur in various orders and/or concurrently. Additionally, other steps or operations not presented and described herein may be used. Furthermore, not all illustrated steps or operations may be required to implement a technique in accordance with the disclosed subject matter.

At 510, the technique 500 may include generating, using a machine learning component (e.g., machine learning component 118), a taxonomical data structure based on multi-modal unstructured enterprise data and unstructured external data. In some implementations, this step may involve extracting a set of datum from the multi-modal unstructured enterprise data using a multi-model natural language processing operation. The natural language processing operation may include entity recognition and context understanding techniques to accurately interpret and categorize information from various sources, including text documents, audio recordings, and video content.

In some implementations, the machine learning component may include a generative artificial intelligence component. The generative artificial intelligence component may be used to generate the taxonomical data structure, which may include a set of topic nodes, a set of sub-topic nodes, and a set of datum nodes. The taxonomical data structure may organize topics into a hierarchical arrangement, with main topic nodes at the top level branching into multiple sub-topic nodes at lower levels.

At 520, the technique 500 may include constructing, using the machine learning component (e.g., machine learning component 118) and based on the taxonomical data structure, a taxonomized knowledge graph. In some implementations, this step may involve creating a network of interconnected nodes and edges representing entities, concepts, and their relationships within the organization's data ecosystem. The knowledge graph may facilitate complex queries, relationship discovery, and impact analysis when new information is introduced to the system.

In some implementations, the technique 500 may include creating, based on the taxonomical data structure, a taxonomical data library. The taxonomical data library may serve as a reference for categorizing new information and maintaining consistency in data classification across the organization. The taxonomical data library may be stored in a data store (e.g., data store 120) for efficient retrieval and updating of taxonomical information.

At 530, the technique 500 may include obtaining new data from at least one of an external data source (e.g., external data source 108B) or an internal data source (e.g., internal data source 108A). In some implementations, the new data may include at least one of an updated process document, an updated policy document, an updated process guide, an updated policy guide, or a regulatory update. The new data may be processed through a data intake engine (e.g., data intake engine 114) and then analyzed by various components of a dynamic data system (e.g., dynamic data system 116).

In some implementations, the technique 500 may include performing, based on a connected external data source, at least one of a fact checking operation or a verification operation associated with the new data. This step may help ensure the validity and consistency of the information being processed and acted upon.

At 540, the technique 500 may include inferring, using the machine learning component (e.g., machine learning component 118) and based on the taxonomized knowledge graph and the new data, an action associated with the new data. In some implementations, this step may involve determining, based on the taxonomized knowledge graph and the new data, at least one impacted team associated with the new data. The technique 500 may further include determining, based on a set of severity factors, a weighted severity score associated with the new data.

In some implementations, the technique 500 may include determining, based on the taxonomized knowledge graph and the new data, an impact score associated with the new data. The action may be inferred based on the impact score and the weighted severity score. Additionally, the technique 500 may include determining a set of candidate actions based on the new data and the taxonomical data structure, and determining a set of estimated costs associated with the set of candidate actions. The action may be inferred based on the set of estimated costs.

At 550, the technique 500 may include outputting an indication of the action. In some implementations, this step may involve outputting indication data configured to cause a computing device to present a representation of the action. The technique 500 may further include receiving, via the computing device, a set of user feedback associated with the representation of the action, and updating, based on the set of user feedback, the machine learning component.

In some implementations, the technique 500 may include performing the action based on the indication of the action. Performing the action may include at least one of: outputting a notification based on the new data, updating a set of process documents, updating a set of policy documents, or providing a set of instructions associated with the new data.

The technique 500 may include additional steps for enhancing the accuracy and reliability of its outputs. For example, the technique 500 may include outputting library data configured to cause a computing device to present a representation of a taxonomical data library based on the taxonomical data structure. The technique 500 may further include receiving, via the computing device, a set of user feedback associated with the representation of the taxonomical data library, and updating, based on the set of user feedback, the machine learning component.

Similarly, the technique 500 may include outputting severity score data configured to cause a computing device to present a representation of a weighted severity score associated with the new data. The technique 500 may further include receiving, via the computing device, a set of user feedback associated with the representation of the weighted severity score, and updating, based on the set of user feedback, the machine learning component.

In some implementations, the technique 500 may include outputting impact score data configured to cause a computing device to present a representation of an impact score associated with the new data. The technique 500 may further include receiving, via the computing device, a set of user feedback associated with the representation of the impact score, and updating, based on the set of user feedback, the machine learning component.

The technique 500 may facilitate efficient analysis of new information against current state policies and procedures, assessment of the impact of changes, and action on at-risk or non-compliant items. By leveraging advanced machine learning techniques and a comprehensive knowledge graph structure, the technique 500 may provide timely, relevant, and actionable insights to support decision-making and maintain regulatory compliance.

According to an aspect of the disclosure, there is provided a computer-implemented method. The method includes generating a taxonomical data structure based on multi-modal unstructured enterprise data and unstructured external data using a machine learning component. The method constructs a taxonomized knowledge graph based on the taxonomical data structure using the machine learning component. The method obtains new data from at least one of an external data source or an internal data source. The method infers an action associated with the new data using the machine learning component and based on the taxonomized knowledge graph and the new data. The method outputs an indication of the action. This method improves the efficiency of processing and analyzing diverse unstructured data sources by utilizing a specialized taxonomized knowledge graph structure. Additionally, the method enhances decision-making capabilities by automatically inferring appropriate actions based on new information in the context of existing organizational knowledge.

In embodiments, the method can include performing the action based on the indication of the action. Performing the action can include at least one of: outputting a notification based on the new data, updating a set of process documents, updating a set of policy documents, or providing a set of instructions associated with the new data. This has the technical effect of automating responses to new information, reducing manual effort and potential human error in updating organizational processes and policies.

In embodiments, the method can include extracting a set of datum from the multi-modal unstructured enterprise data based on a multi-model natural language processing operation. This has the technical effect of efficiently processing diverse data formats, including text, audio, and video content, to extract relevant information.

In embodiments, the method can include extracting a set of datum from the multi-modal unstructured enterprise data based on an entity recognition operation. This has the technical effect of accurately identifying and categorizing key entities within unstructured data, improving the overall quality of the taxonomical data structure.

In embodiments, the method can include extracting a set of datum from the multi-modal unstructured enterprise data based on a context understanding operation. This has the technical effect of capturing nuanced relationships and meanings within the data, enhancing the accuracy of the taxonomized knowledge graph.

In embodiments, the machine learning component can include a generative artificial intelligence component, and generating the taxonomical data structure can include using the generative artificial intelligence component. This has the technical effect of leveraging advanced AI capabilities to create more comprehensive and adaptable taxonomical structures.

In embodiments, the method can include creating a taxonomical data library based on the taxonomical data structure. This has the technical effect of providing a centralized reference for consistent data classification across the organization, improving data management efficiency.

In embodiments, the method can include determining a weighted severity score associated with the new data based on a set of severity factors. The action can be inferred based on the weighted severity score. This has the technical effect of prioritizing actions based on the potential impact and urgency of new information, enabling more effective resource allocation.

In embodiments, the method can include determining at least one impacted team associated with the new data based on the taxonomized knowledge graph and the new data. The method can determine a weighted severity score associated with the new data based on a set of severity factors. The method can determine an impact score associated with the new data based on the taxonomized knowledge graph and the new data. The action can be inferred based on the impact score and the weighted severity score. This has the technical effect of providing a comprehensive assessment of the implications of new information, enabling more targeted and effective responses across the organization.

According to another aspect of the disclosure, there is provided a computer program product. The computer program product includes one or more computer-readable storage media and program instructions stored on the one or more computer-readable storage media to perform operations. The operations include generating a taxonomical data structure based on multi-modal unstructured enterprise data and unstructured external data using a machine learning component. The operations construct a taxonomized knowledge graph based on the taxonomical data structure using the machine learning component. The operations obtain new data from at least one of an external data source or an internal data source. The operations infer an action associated with the new data using the machine learning component and based on the taxonomized knowledge graph and the new data. The operations output an indication of the action. This computer program product improves the scalability and consistency of data management and analysis across an organization by encapsulating the dynamic data management process in a reusable software package. Additionally, it enables easier integration of advanced data analysis capabilities into existing enterprise systems.

In embodiments, the taxonomical data structure can include a set of topic nodes, a set of sub-topic nodes, and a set of datum nodes. This has the technical effect of creating a hierarchical representation of organizational knowledge, facilitating efficient navigation and analysis of complex information structures.

In embodiments, the operations can include determining at least one impacted team associated with the new data based on the taxonomized knowledge graph and the new data. The operations can determine an impact score associated with the new data based on the taxonomized knowledge graph and the new data. The action can be inferred based on the impact score. This has the technical effect of automatically identifying relevant stakeholders and quantifying the potential effects of new information, enabling more informed decision-making.

In embodiments, the operations can include determining a set of candidate actions based on the new data and the taxonomical data structure. The operations can determine a set of estimated costs associated with the set of candidate actions. The action can be inferred based on the set of estimated costs. This has the technical effect of optimizing action selection by considering both potential impacts and resource requirements, improving overall operational efficiency.

In embodiments, the operations can include outputting library data configured to cause a computing device to present a representation of a taxonomical data library based on the taxonomical data structure. The operations can receive a set of user feedback associated with the representation of the taxonomical data library via the computing device. The operations can update the machine learning component based on the set of user feedback. This has the technical effect of continuously improving the accuracy and relevance of the taxonomical structure through user input, enhancing the system's adaptability to organizational needs.

In embodiments, the operations can include outputting severity score data configured to cause a computing device to present a representation of a weighted severity score associated with the new data. The operations can receive a set of user feedback associated with the representation of the weighted severity score via the computing device. The operations can update the machine learning component based on the set of user feedback. This has the technical effect of refining the severity assessment process over time, improving the system's ability to accurately prioritize new information and actions.

According to another aspect of the disclosure, there is provided a computer system. The computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component. The operations construct a taxonomized knowledge graph based on the taxonomical data structure using the machine learning component. The operations obtain new data from at least one of an external data source or an internal data source. The operations infer an action associated with the new data using the machine learning component and based on the taxonomized knowledge graph and the new data. The operations output an indication of the action. This computer system improves the processing efficiency and analytical capabilities of enterprise data management systems by leveraging specialized hardware and software configurations. Additionally, the system enhances organizational agility by providing real-time analysis and action recommendations based on new information.

In embodiments, the operations can include outputting impact score data configured to cause a computing device to present a representation of an impact score associated with the new data. The operations can receive a set of user feedback associated with the representation of the impact score via the computing device. The operations can update the machine learning component based on the set of user feedback. This has the technical effect of continuously improving the accuracy of impact assessments through user feedback, enhancing the system's ability to predict and quantify the effects of new information.

In embodiments, outputting the indication of the action can include outputting indication data configured to cause a computing device to present a representation of the action. The operations can include receiving a set of user feedback associated with the representation of the action via the computing device. The operations can update the machine learning component based on the set of user feedback. This has the technical effect of refining the action inference process over time, improving the relevance and effectiveness of recommended actions.

In embodiments, the operations can include performing at least one of a fact checking operation or a verification operation associated with the new data based on a connected external data source. This has the technical effect of enhancing the reliability and accuracy of the information being processed, reducing the risk of acting on incorrect or outdated data.

In embodiments, the new data can include at least one of an updated process document, an updated policy document, an updated process guide, an updated policy guide, or a regulatory update. This has the technical effect of enabling the system to handle a wide range of organizational and regulatory changes, improving overall compliance and operational efficiency.

In one implementation, a computer-implemented method includes generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, and performing the action based on the indication of the action. Performing the action includes at least one of: outputting a notification based on the new data, updating a set of process documents, updating a set of policy documents, or providing a set of instructions associated with the new data. This implementation provides a comprehensive approach to dynamic data management that not only analyzes and categorizes diverse data sources but also takes concrete actions based on new information. The automated action execution enhances organizational responsiveness and reduces the lag time between identifying necessary changes and implementing them, thereby improving overall operational efficiency and compliance.

In another implementation, a computer-implemented method includes generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, and extracting a set of datum from the multi-modal unstructured enterprise data based on a multi-model natural language processing operation. This implementation enhances the system's ability to process and understand complex, unstructured data from multiple sources and formats. The multi-model natural language processing operation enables more accurate and nuanced interpretation of diverse data inputs, leading to a more comprehensive and contextually rich taxonomical data structure and knowledge graph.

In a further implementation, a computer-implemented method includes generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, extracting a set of datum from the multi-modal unstructured enterprise data based on a multi-model natural language processing operation, extracting a set of datum from the multi-modal unstructured enterprise data based on an entity recognition operation, and extracting a set of datum from the multi-modal unstructured enterprise data based on a context understanding operation. This implementation provides a multi-faceted approach to data extraction and analysis, combining natural language processing, entity recognition, and context understanding. The synergy of these techniques allows for more accurate identification of key information, relationships, and contextual nuances within the data, resulting in a more sophisticated and insightful knowledge representation. This comprehensive extraction process enhances the system's ability to make informed inferences and recommendations based on a deeper understanding of the data's content and context.

In yet another implementation, a computer-implemented method includes generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, determining at least one impacted team associated with the new data based on the taxonomized knowledge graph and the new data, determining a weighted severity score associated with the new data based on a set of severity factors, and determining an impact score associated with the new data based on the taxonomized knowledge graph and the new data. The action is inferred based on the impact score and the weighted severity score. This implementation provides a sophisticated approach to assessing the implications of new data within an organization. By identifying impacted teams, calculating weighted severity scores, and determining impact scores, the system can prioritize actions and allocate resources more effectively. The combination of these assessments enables more targeted and proportionate responses to new information, improving organizational agility and decision-making processes.

In one implementation, a computer program product includes one or more computer-readable storage media and program instructions stored on the one or more computer-readable storage media to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, determining at least one impacted team associated with the new data based on the taxonomized knowledge graph and the new data, and determining an impact score associated with the new data based on the taxonomized knowledge graph and the new data. The action is inferred based on the impact score. This implementation enhances the system's ability to assess the implications of new data across the organization. By identifying impacted teams and calculating an impact score, the system can more accurately prioritize actions and allocate resources. This targeted approach to action inference improves organizational responsiveness and efficiency in handling new information.

In another implementation, a computer program product includes one or more computer-readable storage media and program instructions stored on the one or more computer-readable storage media to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, determining a set of candidate actions based on the new data and the taxonomical data structure, and determining a set of estimated costs associated with the set of candidate actions. The action is inferred based on the set of estimated costs. This implementation introduces a cost-aware decision-making process to the system. By considering estimated costs associated with potential actions, the system can make more economically efficient recommendations. This approach helps organizations balance the need for action against resource constraints, leading to more pragmatic and financially sound decision-making in response to new information.

In a further implementation, a computer program product includes one or more computer-readable storage media and program instructions stored on the one or more computer-readable storage media to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, outputting library data configured to cause a computing device to present a representation of a taxonomical data library based on the taxonomical data structure, receiving a set of user feedback associated with the representation of the taxonomical data library via the computing device, and updating the machine learning component based on the set of user feedback. This implementation incorporates a feedback loop that allows for continuous improvement of the system. By presenting a visual representation of the taxonomical data library and incorporating user feedback, the system can refine its understanding and organization of information over time. This adaptive approach enhances the accuracy and relevance of the system's knowledge representation, leading to more effective data management and decision-making processes.

In one implementation, a computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, outputting impact score data configured to cause a computing device to present a representation of an impact score associated with the new data, receiving a set of user feedback associated with the representation of the impact score via the computing device, and updating the machine learning component based on the set of user feedback. This implementation enhances the system's ability to assess and communicate the potential impact of new information. By visualizing impact scores and incorporating user feedback, the system can refine its impact assessment capabilities over time. This iterative process leads to more accurate and contextually relevant impact evaluations, enabling better-informed decision-making across the organization.

In another implementation, a computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, and outputting an indication of the action. Outputting the indication of the action includes outputting indication data configured to cause a computing device to present a representation of the action. The operations further include receiving a set of user feedback associated with the representation of the action via the computing device and updating the machine learning component based on the set of user feedback. This implementation creates a feedback loop for refining the system's action inference capabilities. By presenting visual representations of recommended actions and incorporating user feedback, the system can continuously improve its ability to suggest relevant and effective actions. This adaptive approach leads to more accurate and contextually appropriate action recommendations over time, enhancing the overall effectiveness of the dynamic data management system.

In a further implementation, a computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, and performing at least one of a fact checking operation or a verification operation associated with the new data based on a connected external data source. This implementation enhances the reliability and accuracy of the system's inputs and outputs. By incorporating fact-checking and verification processes, the system can ensure the validity of new information before it is integrated into the knowledge graph or used to infer actions. This additional layer of validation improves the overall trustworthiness of the system's recommendations and reduces the risk of acting on incorrect or outdated information.

In yet another implementation, a computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, outputting impact score data configured to cause a computing device to present a representation of an impact score associated with the new data, receiving a set of user feedback associated with the representation of the impact score via the computing device, updating the machine learning component based on the set of user feedback, outputting indication data configured to cause a computing device to present a representation of the action, receiving a set of user feedback associated with the representation of the action via the computing device, and updating the machine learning component based on the set of user feedback. This implementation combines multiple feedback loops to enhance both impact assessment and action recommendation capabilities. By incorporating user feedback on both impact scores and suggested actions, the system can simultaneously refine its ability to evaluate the significance of new information and recommend appropriate responses. This dual-feedback approach leads to a more comprehensive and accurate dynamic data management system, capable of providing increasingly relevant and effective insights and recommendations over time.

In a final implementation, a computer system includes a processor set, one or more computer-readable storage media, and program instructions stored on the one or more computer-readable storage media to cause the processor set to perform operations. The operations include generating a taxonomical data structure based on multi-modal unstructured enterprise data and unstructured external data using a machine learning component, constructing a taxonomized knowledge graph based on the taxonomical data structure using the machine learning component, obtaining new data from at least one of an external data source or an internal data source, inferring an action associated with the new data using the machine learning component and based on the taxonomized knowledge graph and the new data, outputting an indication of the action, outputting impact score data configured to cause a computing device to present a representation of an impact score associated with the new data, receiving a set of user feedback associated with the representation of the impact score via the computing device, updating the machine learning component based on the set of user feedback, outputting indication data configured to cause a computing device to present a representation of the action, receiving a set of user feedback associated with the representation of the action via the computing device, updating the machine learning component based on the set of user feedback, and performing at least one of a fact checking operation or a verification operation associated with the new data based on a connected external data source. This comprehensive implementation combines multiple feedback loops with data validation processes to create a highly refined and trustworthy dynamic data management system. By incorporating user feedback on impact assessments and action recommendations, while also performing fact-checking and verification operations, the system can continuously improve its accuracy, relevance, and reliability. This multi-faceted approach ensures that the system not only learns from user interactions but also maintains data integrity, resulting in a robust and adaptive solution for managing complex, evolving information landscapes within organizations.

In one implementation, the dynamic data management system is applied within a large wealth management firm to streamline their AML processes. An AML analyst named Heeseo is conducting a periodic review of a high-risk account, referencing a 200-page process guide that outlines policies and procedures. As new regulatory guidance is received from external sources and internal policy updates are made, the system automatically ingests this information and updates the knowledge graph. When a significant change occurs, such as a new requirement for enhanced due diligence on certain types of transactions, the system analyzes the impact across various teams and processes.

The system determines that this update has a high severity score of 0.88 (on a scale of 0 to 1) due to its regulatory nature and broad impact. It also calculates an impact score of 0.75, indicating significant effects across multiple teams including AML, KYC, and Transaction Monitoring. Based on these scores, the system automatically generates a detailed action plan. This includes updating relevant sections of the process guide, scheduling cross-team meetings to plan implementation strategies, and creating a targeted training program for affected analysts.

An administrator receives a high-priority notification about these changes, with specific instructions on how they affect her review process. The system provides her with a side-by-side comparison of the old and new procedures, highlighting exactly what has changed and how it impacts her workflow. This ensures that the administrator can immediately adapt her review methodology to comply with the new requirements, without needing to manually search through lengthy email threads or attend multiple explanatory meetings.

Furthermore, the system's feedback loop allows the administrator and other users to provide input on the relevance and clarity of the updates. This feedback is used to refine the system's understanding of the organizational structure and improve future impact assessments and action recommendations. By streamlining the process of implementing regulatory changes and ensuring consistent application across all affected teams, the system significantly reduces the risk of non-compliance and improves the overall efficiency of the AML review process.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
generating, using a machine learning component, a taxonomical data structure based on multi-modal unstructured enterprise data and unstructured external data;
constructing, using the machine learning component and based on the taxonomical data structure, a taxonomized knowledge graph;
obtaining new data from at least one of an external data source or an internal data source;
inferring, using the machine learning component and based on the taxonomized knowledge graph and the new data, an action associated with the new data; and
outputting an indication of the action.

2. The computer-implemented method of claim 1, further comprising performing the action based on the indication of the action, and wherein performing the action comprises at least one of:
outputting a notification based on the new data;
updating a set of process documents;
updating a set of policy documents; or
providing a set of instructions associated with the new data.

3. The computer-implemented method of claim 1, further comprising:
extracting, from the multi-modal unstructured enterprise data, a set of datum based on a multi-model natural language processing operation.

4. The computer-implemented method of claim 1, further comprising:
extracting, from the multi-modal unstructured enterprise data, a set of datum based on an entity recognition operation.

5. The computer-implemented method of claim 1, further comprising:
extracting, from the multi-modal unstructured enterprise data, a set of datum based on a context understanding operation.

6. The computer-implemented method of claim 1, wherein the machine learning component comprises a generative artificial intelligence component, and wherein generating the taxonomical data structure comprises:
generating, using the generative artificial intelligence component, the taxonomical data structure.

7. The computer-implemented method of claim 1, further comprising:
creating, based on the taxonomical data structure, a taxonomical data library.

8. The computer-implemented method of claim 1, further comprising:
determining, based on a set of severity factors, a weighted severity score associated with the new data, and wherein the action is inferred based on the weighted severity score.

9. The computer-implemented method of claim 1, further comprising:
determining, based on the taxonomized knowledge graph and the new data, at least one impacted team associated with the new data;
determining, based on a set of severity factors, a weighted severity score associated with the new data; and
determining, based on the taxonomized knowledge graph and the new data, an impact score associated with the new data, and wherein the action is inferred based on the impact score and the weighted severity score.

10. A computer program product, comprising:
one or more computer-readable storage media; and
program instructions stored on the one or more computer-readable storage media to perform operations, comprising:
generating, using a machine learning component, a taxonomical data structure based on multi-modal unstructured enterprise data and unstructured external data;
constructing, using the machine learning component and based on the taxonomical data structure, a taxonomized knowledge graph;
obtaining new data from at least one of an external data source or an internal data source;
inferring, using the machine learning component and based on the taxonomized knowledge graph and the new data, an action associated with the new data; and
outputting an indication of the action.

11. The computer program product of claim 10, wherein the taxonomical data structure comprises a set of topic nodes, a set of sub-topic nodes, and a set of datum nodes.

12. The computer program product of claim 10, the operations further comprising:
determining, based on the taxonomized knowledge graph and the new data, at least one impacted team associated with the new data; and
determining, based on the taxonomized knowledge graph and the new data, an impact score associated with the new data, and wherein the action is inferred based on the impact score.

13. The computer program product of claim 10, the operations further comprising:
determining, a set of candidate actions based on the new data and the taxonomical data structure; and
determining a set of estimated costs associated with the set of candidate actions, and wherein the action is inferred based on the set of estimated costs.

14. The computer program product of claim 10, the operations further comprising:
outputting library data configured to cause a computing device to present a representation of a taxonomical data library based on the taxonomical data structure;
receiving, via the computing device, a set of user feedback associated with the representation of the taxonomical data library; and
updating, based on the set of user feedback, the machine learning component.

15. The computer program product of claim 10, the operations further comprising:
outputting severity score data configured to cause a computing device to present a representation of a weighted severity score associated with the new data;
receiving, via the computing device, a set of user feedback associated with the representation of the weighted severity score; and
updating, based on the set of user feedback, the machine learning component.

16. A computer system, comprising:
a processor set;
one or more computer-readable storage media; and
program instructions stored on the one or more computer-readable storage media to cause the processor set to perform operations comprising:
generating, using a machine learning component, a taxonomical data structure based on multi-modal unstructured enterprise data and unstructured external data;
constructing, using the machine learning component and based on the taxonomical data structure, a taxonomized knowledge graph;
obtaining new data from at least one of an external data source or an internal data source;
inferring, using the machine learning component and based on the taxonomized knowledge graph and the new data, an action associated with the new data; and
outputting an indication of the action.

17. The computer system of claim 16, the operations further comprising:
outputting impact score data configured to cause a computing device to present a representation of an impact score associated with the new data;
receiving, via the computing device, a set of user feedback associated with the representation of the impact score; and
updating, based on the set of user feedback, the machine learning component.

18. The computer system of claim 16, wherein outputting the indication of the action comprises outputting indication data configured to cause a computing device to present a representation of the action, and wherein the operations further comprise:
receiving, via the computing device, a set of user feedback associated with the representation of the action; and
updating, based on the set of user feedback, the machine learning component.

19. The computer system of claim 16, the operations further comprising:
performing, based on a connected external data source, at least one of a fact checking operation or a verification operation associated with the new data.

20. The computer system of claim 16, wherein the new data comprises at least one of an updated process document, an updated policy document, an updated process guide, an updated policy guide, or a regulatory update.
